(19) United States
(12) Patent Application Publication
(10) Pub. No.: US 2025/0284095 A1
(43) Pub. Date: Sep. 11, 2025

(54) CAMERA OPTICAL LENS

(71) Applicant: AAC OPTICS (CHANGZHOU) CO., LTD., Changzhou (CN)

(72) Inventors: Qun Sun, Changzhou (CN); Shunda Zhou, Changzhou (CN)

(21) Appl. No.: 18/733,594

(22) Filed: Jun. 4, 2024

Related U.S. Application Data
(63) Continuation of application No. PCT/CN2024/080155, filed on Mar. 5, 2024.

(51) Int. Cl. G02B 13/00; G02B 1/04; G02B 9/62

(52) U.S. Cl. CPC G02B 13/0045; G02B 1/041; G02B 9/62; G02B 13/0055; G02B 13/008

(57) ABSTRACT

A camera optical lens is provided according to the present disclosure, which includes in sequence from an object side to an image side: a first lens, a second lens, a third lens, a fourth lens, a fifth lens, and a sixth lens. The camera optical lens satisfies the following conditions: nd1≥1.70, and (FOV*f)/IH≥120.00. nd1 represents a refractive index of the first lens, FOV represents a field of view of the camera optical lens, f represents a focal length of the camera optical lens, and IH represents an image height of the camera optical lens. The camera optical lens according to the present disclosure has good optical performance, and can meet the design requirements of large aperture and miniaturization with good reception effect.

### CROSS REFERENCE TO RELATED APPLICATIONS

The present application is a continuation of PCT patent Application No. PCT/CN2024/080155, filed on Mar. 5, 2024, which is incorporated by reference herein in its entirety.

### TECHNICAL FIELD

Embodiments of the present disclosure relate to the technical field of optics, and in particular to a camera optical lens.

### BACKGROUND

With the development of intelligent driving, in-vehicle lens is also rapidly updated and iterated. An in-vehicle camera is favored by developers of autonomous driving technology because of its clear imaging effect. However, the in-vehicle camera is easily affected by environmental factors (such as strong light, rain and snow, etc.), which leads to poor shooting effect. Based on this, the use of an in-vehicle laser radar to supplement the information received by the in-vehicle lens is of great significance. The laser radar detects the target, obtains the target light wave signal from the reflected light, and processes the information together with the transmitted signal to obtain the distance, speed, azimuth and other information of the detected target. For the laser radar, the camera optical lens is an indispensable part of the laser radar. The camera optical lens can collimate the beam of the laser radar to improve the detection effect.

However, the existing camera optical lens of the laser radar still cannot meet the design requirements of large aperture and miniaturization, and the reception effect is poor, which is difficult to meet the application requirements of intelligent driving.

### SUMMARY

Embodiments of the present disclosure provide a camera optical lens, which has good optical performance and can meet the design requirements of large aperture and miniaturization with good reception effect.

In order to solve the above technical problems, a camera optical lens is provided according to the present disclosure, which includes in sequence from an object side to an image side: a first lens, a second lens, a third lens, a fourth lens, a fifth lens, and a sixth lens. The camera optical lens satisfies the following conditions: nd1≥1.70, and (FOV*f)/IH≥120.00. nd1 represents a refractive index of the first lens, FOV represents a field of view of the camera optical lens, f represents a focal length of the camera optical lens, and IH represents an image height of the camera optical lens.

As an improvement, the camera optical lens further satisfies the following condition: −5.00≤R5/R6≤−1.20. R5 represents a curvature radius of an object-side surface of the third lens, and R6 represents a curvature radius of an image-side surface of the third lens.

As an improvement, the camera optical lens further satisfies the following condition: −4.00≤R7/R8≤−1.00. R7 represents a curvature radius of an object-side surface of the fourth lens, and R8 represents a curvature radius of an image-side surface of the fourth lens.

As an improvement, the camera optical lens further satisfies the following condition: 1.40≤d9/d11≤5.00. d9 represents an on-axis thickness of the fifth lens, and d11 represents an on-axis thickness of the sixth lens.

As an improvement, the camera optical lens further satisfies the following condition: −6.00≤f12/f≤−1.20. f12 represents a combined focal length of the first lens and the second lens.

As an improvement, the field of view FOV and the focal length f further satisfy the following condition: (FOV*f)/IH≤150.00.

As an improvement, the first lens has a negative refractive power, and an image-side surface of the first lens is concave in a paraxial region. The camera optical lens further satisfies the following conditions: 0.33≤(R1+R2)/(R1−R2)≤1.97, −3.54≤f1/f≤−0.54, and 0.02≤d1/TTL≤0.22. R1 represents a curvature radius of an object-side surface of the first lens, R2 represents a curvature radius of the image-side surface of the first lens, f1 represents a focal length of the first lens, d1 represents an on-axis thickness of the first lens, and TTL represents a total track length of the camera optical lens.

As an improvement, the second lens has a positive refractive power, an object-side surface of the second lens is concave in a paraxial region, and an image-side surface of the second lens is convex in the paraxial region. The camera optical lens further satisfies the following conditions: 0.54≤(R3+R4)/(R3−R4)≤1.71, 1.66≤f2/f≤5.87, and 0.02≤d3/TTL≤0.09. R3 represents a curvature radius of the object-side surface of the second lens, R4 represents a curvature radius of the image-side surface of the second lens, f2 represents a focal length of the second lens, d3 represents an on-axis thickness of the second lens, and TTL represents a total track length of the camera optical lens.

As an improvement, the third lens has a negative refractive power, an object-side surface of the third lens is concave in a paraxial region, and an image-side surface of the third lens is concave in the paraxial region. The camera optical lens further satisfies the following conditions: 0.05≤(R5+R6)/(R5−R6)≤1.00, −7.30≤f3/f≤−1.56, and 0.02≤d5/TTL≤0.12. R5 represents a curvature radius of the object-side surface of the third lens, R6 represents a curvature radius of the image-side surface of the third lens, f3 represents a focal length of the third lens, d5 represents an on-axis thickness of the third lens, and TTL represents a total track length of the camera optical lens.

As an improvement, the fourth lens has a positive refractive power, an object-side surface of the fourth lens is convex in a paraxial region, and an image-side surface of the fourth lens is convex in the paraxial region. The camera optical lens further satisfies the following conditions: 0.00≤(R7+R8)/(R7−R8)≤0.90, 0.61≤f4/f≤2.69, and 0.03≤d7/TTL≤0.27. R7 represents a curvature radius of the object-side surface of the fourth lens, R8 represents a curvature radius of the image-side surface of the fourth lens, f4 represents a focal length of the fourth lens, d7 represents an on-axis thickness of the fourth lens, and TTL represents a total track length of the camera optical lens.

As an improvement, the fifth lens has a positive refractive power, an object-side surface of the fifth lens is convex in a paraxial region, and an image-side surface of the fifth lens is concave in the paraxial region. The camera optical lens further satisfies the following conditions: −17.54≤(R9+R10)/(R9−R10)≤−1.95, 4.38≤f5/f≤45.60, and 0.06≤d9/TTL≤0.36. R9 represents a curvature radius of the object-side surface of the fifth lens, R10 represents a curvature radius of the image-side surface of the fifth lens, f5 represents a focal length of the fifth lens, d9 represents an on-axis thickness of the fifth lens, and TTL represents a total track length of the camera optical lens.

As an improvement, the sixth lens has a positive refractive power, an object-side surface of the sixth lens is convex in a paraxial region, and an image-side surface of the sixth lens is concave in the paraxial region. The camera optical lens further satisfies the following conditions: −5.98≤(R11+R12)/(R11−R12)≤−1.50; 0.92≤f6/f≤4.36; and 0.02≤d11/TTL≤0.14. R11 represents a curvature radius of the object-side surface of the sixth lens, R12 represents a curvature radius of the image-side surface of the sixth lens, f6 represents a focal length of the sixth lens, d11 represents an on-axis thickness of the sixth lens, and TTL represents a total track length of the camera optical lens.

As an improvement, the fourth lens is made of glass.

The beneficial effects of the present disclosure are that, by the configuration of the lens as described above, the camera optical lens according to the present disclosure has good optical performance, a large aperture, miniaturization, and good reception effect.

### BRIEF DESCRIPTION OF THE DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic structural view of a camera optical lens according to a first embodiment of the present disclosure;

FIG. 2 is a schematic diagram of a field curvature and a distortion of the camera optical lens shown in FIG. 1;

FIG. 3 is a schematic diagram of a lateral color of the camera optical lens shown in FIG. 1;

FIG. 4 is a schematic diagram of a longitudinal aberration of the camera optical lens shown in FIG. 1;

FIG. 5 is a schematic structural diagram of a camera optical lens according to a second embodiment of the present disclosure;

FIG. 6 is a schematic diagram of a field curvature and a distortion of the camera optical lens shown in FIG. 5;

FIG. 7 is a schematic diagram of a lateral color of the camera optical lens shown in FIG. 5;

FIG. 8 is a schematic diagram of a longitudinal aberration of the camera optical lens shown in FIG. 5;

FIG. 9 is a schematic structural diagram of a camera optical lens according to a third embodiment of the present disclosure;

FIG. 10 is a schematic diagram of a field curvature and a distortion of the camera optical lens shown in FIG. 9;

FIG. 11 is a schematic diagram of a lateral color of the camera optical lens shown in FIG. 9;

FIG. 12 is a schematic diagram of a longitudinal aberration of the camera optical lens shown in FIG. 9;

FIG. 13 is a schematic structural diagram of a camera optical lens according to a fourth embodiment of the present disclosure;

FIG. 14 is a schematic diagram of a field curvature and a distortion of the camera optical lens shown in FIG. 13;

FIG. 15 is a schematic diagram of a lateral color of the camera optical lens shown in FIG. 13;

FIG. 16 is a schematic diagram of a longitudinal aberration of the camera optical lens shown in FIG. 13;

FIG. 17 is a schematic structural diagram of a camera optical lens according to a fifth embodiment of the present disclosure;

FIG. 18 is a schematic diagram of a field curvature and a distortion of the camera optical lens shown in FIG. 17;

FIG. 19 is a schematic diagram of a lateral color of the camera optical lens shown in FIG. 17;

FIG. 20 is a schematic diagram of a longitudinal aberration of the camera optical lens shown in FIG. 17;

FIG. 21 is a schematic diagram of the structure of a camera optical lens according to a comparative embodiment of the present disclosure;

FIG. 22 is a schematic diagram of a field curvature and a distortion of the camera optical lens shown in FIG. 21;

FIG. 23 is a schematic diagram of a lateral color of the camera optical lens shown in FIG. 21;

FIG. 24 is a schematic diagram of a longitudinal aberration of the camera optical lens shown in FIG. 21.

### DETAILED DESCRIPTION OF THE EMBODIMENTS

To make the objects, technical solutions, and advantages of the present disclosure clearer, embodiments of the present disclosure are described in detail with reference to accompanying drawings in the following. A person of ordinary skill in the art can understand that, in the embodiments of the present disclosure, many technical details are provided to make readers better understand the present disclosure. However, even without these technical details and any changes and modifications based on the following embodiments, technical solutions required to be protected by the present disclosure can be implemented.

In the present disclosure embodiment, the terms “top”, “bottom”, “left”, “right”, “front”, “back”, “top”, “bottom”, “inside”, “outside”, “center”, “vertical”, “horizontal”, “transverse”, “longitudinal”, etc. indicate that the orientation or positional relationship is based on the orientation or positional relationship shown in the accompanying drawings. These terms are primarily intended to better describe the present disclosure and its embodiments, and are not intended to qualify that the indicated device, element, or component must have a particular orientation, or be constructed and operated in a particular orientation.

Moreover, some of the above terms may be used to indicate other meanings in addition to an orientation or positional relationship, for example, the term “on” may also be used to indicate a certain dependency or connection relationship in some cases. To a person of ordinary skill in the art, the specific meaning of these terms in the present disclosure may be understood according to the specific circumstances.

In addition, the terms “mount”, “set”, “provide”, “open”, “connect”, “inter-connect” should be understood in a broad sense. For example, it may be a fixed connection, a removable connection, or a monolithic construction; it may be a mechanical connection, or an electrical connection; it may be a direct connection, or an indirect connection through an intermediate medium, or an internal connection between two devices, elements, or components. To a person of ordinary skill in the art, the specific meanings of the above terms in the present disclosure may be understood according to the specific circumstances.

In addition, the terms “first”, “second”, etc. are mainly used to distinguish different devices, elements or components (the specific types and configurations may be the same or different), and are not used to indicate or imply the relative importance and number of the indicated devices, elements or components. Unless otherwise indicated, “plurality” is used primarily to distinguish between different devices, elements or components (which may be of the same specific type and configuration). Unless otherwise indicated, “plurality” means two or more.

In the drawings, the thickness of layers and an area has been enlarged for better understanding and ease of description. When it is described that a part, such as a layer, film, area, or substrate, is “over” or “on” another part, the part may be “directly” on another part or a third part may be present between the two parts. In contrast, when it is described that a part is “directly on” another part, it means that a third part is not present between the two parts. Furthermore, when it is described that a part is “generally” formed on another part, it means the part is not formed on the entire surface (or front surface) of another part and is also not formed in part of the edge of the entire surface.

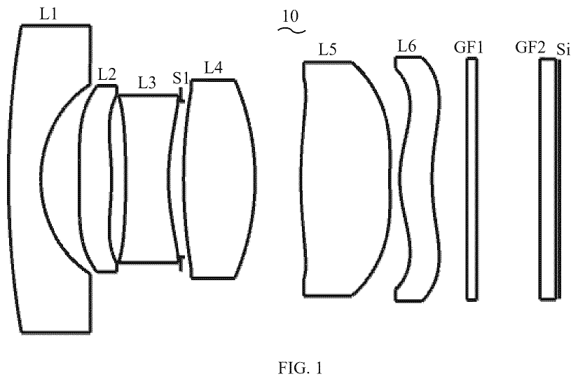

Referring to FIG. 1, a camera optical lens 10 is provided according to a first embodiment of the present disclosure, which includes in sequence from an object side to an image side: a first lens L1, a second lens L2, a third lens L3, a fourth lens L4, a fifth lens L5, and a sixth lens L6. nd1 represents a refractive index of the first lens L1, FOV represents a field of view of the camera optical lens 10, f represents a focal length of the camera optical lens 10, and IH represents an image height of the camera optical lens 10. The camera optical lens 10 satisfies the following conditions:

$$nd 1 \geq 1.7 \qquad ( 1 )$$

$$( FOV * f / IH \geq 12 \; 0.00 \qquad ( 2 )$$

The condition (1) specifies that the refractive index nd1 of the first lens L1 is not less than 1.70, that is, the first lens L1 is preferably made of an optical material with a high refractive index, which is beneficial to controlling a front-end aperture of the camera optical lens 10 and improving the imaging quality.

Moreover, within the range specified in the condition (2), the camera optical lens 10 can simultaneously realize a large field of view angle and a long focal length, thereby realizing medium distance imaging and long distance imaging of the camera optical lens 10.

In this embodiment, a plurality of lenses (L1, L2, L3, L4, L5, L6) are provided, and the refractive index nd1 of the first lens L1 and the camera optical lens 10 are set in the ranges specified in the above conditions (1) and (2), so that the camera optical lens 10 has good optical performance, large aperture, miniaturization, and good reception effect.

Preferably, the refractive index nd1 of the first lens L1 further satisfies the following condition:

$$nd 1 \leq 2.2 \qquad ( 3 )$$

preferably, the camera optical lens 10 further satisfies the following condition:

$$( FOV * f ) / IH \leq 150. \qquad ( 4 )$$

Preferably, f12 represents a combined focal length of the first lens L1 and the second lens L2, f represents a focal length of the camera optical lens 10, and the following condition is satisfied:

$$- 6. \leq f 12 / f \leq - 1.2 \qquad ( 5 )$$

The condition (5) specifies a ratio of the combined focal length f12 of the first lens L1 and the second lens L2 to the focal length f of the camera optical lens 10. Within the range specified in condition (4), an amount of a field curvature of the system can be effectively balanced, so that an offset of the field curvature of the central field of view is less than 0.04 mm, thus the camera optical lens 10 has good imaging accuracy.

Preferably, R5 represents a curvature radius of an object-side surface of the third lens L3, R6 represents a curvature radius of an image-side surface of the third lens L3, and the following condition is satisfied:

$$- 5. \leq R 5 / R 6 \leq - 1.2 \qquad ( 6 )$$

The condition (6) specifies a shape of the third lens L3, and specifies a ratio of the curvature radius R5 of the object-side surface to the curvature radius R6 of the image-side surface of the third lens L3 within the range specified in the condition (6), which can moderate a degree of deflection of the light passing through the third lens L3 and effectively reduce the lateral color LC to satisfy: |LC|≤3.5.

Preferably, R7 represents a curvature radius of an object-side surface of the fourth lens L4, R8 represents a curvature radius of an image-side surface of the fourth lens L4, and the following condition is satisfied:

$$- 4. \leq R 7 / R 8 \leq - 1. \qquad ( 7 )$$

The condition (7) specifies a shape of the fourth lens LA, and specifies a ratio of the curvature radius R7 of the object-side surface to the curvature radius R8 of the image-side surface of the fourth lens L4 within the range specified in the condition (7), which is beneficial to moderating a degree of deflection of the light passing through the fourth lens L4, so that the camera optical lens 10 has good imaging quality and low sensitivity.

Preferably, d9 represents an on-axis thickness of the fifth lens L5, d11 represents an on-axis thickness of the sixth lens L6, and the following condition is satisfied:

$$1.4 \leq d 9 / d 11 \leq 5. \qquad ( 8 )$$

The condition (8) specifies a ratio of the on-axis thickness d9 of the fifth lens L5 to the on-axis thickness d11 of the sixth lens L6, which, within the range specified in the condition (8), is beneficial to controlling thicknesses of the fifth lens L5 and the sixth lens L6, facilitates the injection molding of the fifth lens L5 and the sixth lens L6, and reduces the difficulty in manufacturing of the camera optical lens 10.

In this embodiment, the object-side surface of the first lens L1 is convex in a paraxial region, an image-side surface of the first lens L1 is concave in the paraxial region, and the first lens L1 has a negative refractive power. In other optional embodiments, the first lens L1 may have a positive refractive force, and the object-side surface and image-side surface of the first lens 1 may be configured in other concave and convex arrangements.

Preferably, R1 represents a curvature radius of an object-side surface of the first lens L1, R2 represents a curvature radius of the image-side surface of the first lens L1, f1 represents a focal length of the first lens, f represents a focal length of the camera optical length 10, d1 represents an on-axis thickness of the first lens L1, TTL represents a total track length of the camera optical lens 10, and the following conditions are satisfied:

$$0.33 \leq ( R 1 + R 2 ) / ( R 1 - R 2 ) \leq 1.97 \qquad ( 9 )$$

$$- 3.54 \leq f 1 / f \leq - 0.54 \qquad ( 10 )$$

$$0.02 \leq d 1 / TTL \leq 0.22 \qquad ( 11 )$$

The condition (9) specifies a shape of the first lens L1, which can moderate the degree of deflection of the light passing through the first lens L1 and effectively reduce the aberration with the range of the condition. More preferably, the following condition is satisfied: 0.53≤(R1+R2)/(R1−R2)≤1.57. The condition (10) specifies a ratio of the focal length f1 of the first lens L1 to the focal length f of the camera optical lens 10, which is beneficial to improving the optical performance of the camera optical lens 10 within the range limited by the condition. More preferably, −2.21≤f1/f≤−0.68. The condition (11) specifies a ratio of the on-axis thickness d1 of the first lens L1 to a thickness of the total track length TTL of the camera optical lens 10, which is beneficial to realizing an ultra-thin design of the camera optical lens 10 within the range. More preferably, 0.03≤d1/TTL≤0.17.

In this embodiment, an object-side surface of the second lens L2 is concave in a paraxial region, an image-side surface of the second lens L2 is convex in the paraxial region, and the second lens L2 has a positive refractive power. In other optional embodiments, the object-side surface and the image-side surface of the second lens L2 may be arranged in other concave and convex arrangements, and the second lens L2 may have a negative refractive power.

Preferably, R3 represents a curvature radius of the object-side surface of the second lens L2, R4 represents a curvature radius of the image-side surface of the second lens L2, f2 represents a focal length of the second lens L2, f represents a focal length of the camera optical lens 10, d3 represents an on-axis thickness of the second lens L2, TTL represents a total track length of the camera optical lens 10, and the following conditions are satisfied:

$$0.54 \leq ( R 3 + R 4 ) / ( R 3 - R 4 ) \leq 1.71 \qquad ( 12 )$$

$$1.66 \leq f 2 / f \leq 5 \text{.87} \qquad ( 13 )$$

$$0.02 \leq d 3 / TTL \leq 0.09 \qquad ( 14 )$$

The condition (12) specifies a shape of the second lens L2, which can moderate the degree of deflection of the light passing through the second lens L2 and effectively reduce the aberration with the range limited by the condition. More preferably, the following condition is satisfied: 0.87≤(R3+R4)/(R3−R4)≤1.37. The condition (13) specifies a ratio of the focal length f2 of the second lens L2 to the focal length f of the camera optical lens 10, which is beneficial to improving the optical performance of the camera optical lens 10 within the range. More preferably, 2.65≤f2/f≤4.70. The condition (14) specifies a ratio of the on-axis thickness d3 of the second lens L2 to the total track length TTL of the camera optical lens 10, which is beneficial to compressing the total track length TTL of the camera optical lens 10 and realizing an ultra-thin design of the camera optical lens 10 within the range. More preferably, 0.03≤d3/TTL≤0.07.

In this embodiment, an object-side surface of the third lens L3 is concave in a paraxial region, and an image-side surface of the third lens L3 is concave in the paraxial region, and the third lens has a negative refractive power. In other optional embodiments, the object-side surface and the image-side surface of the third lens L3 may be arranged in other concave and convex arrangements, and the third lens L3 may have a positive refractive power.

Preferably, R5 represents a curvature radius of the object-side surface of the third lens L3, R6 represents a curvature radius of the image-side surface of the third lens L3, f3 represents a focal length of the third lens L3, f represents a focal length of the camera optical lens 10, d5 represents an on-axis thickness of the third lens L3, TTL represents a total track length of the camera optical lens, and the following conditions are satisfied:

$$0.05 \leq ( R 5 + R 6 ) / ( R 5 - R 6 ) \leq 1. \qquad ( 15 )$$

$$- 7.3 \leq f 3 / f \leq - 1.56 \qquad ( 16 )$$

$$0.02 \leq d 5 / TTL \leq 0.12 \qquad ( 17 )$$

The condition (15) specifies a shape of the third lens L3, which can moderate the degree of deflection of the light passing through the third lens L3 and effectively reduce the lateral color to meet |LC|≤3.5. More preferably, the following condition is satisfied: 0.07≤(R5+R6)/(R5−R6)≤0.80. The condition (16) specifies a ratio of the focal length f3 of the third lens L3 to the focal length f of the camera optical lens 10, which is beneficial to reducing the aberration of the camera optical lens 10 and realizing the ultra-thin and wide-angle design of the camera optical lens 10 within the range. More preferably, −4.56≤f3/f≤−1.950. The condition (17) specifies a ratio of the on-axis thickness d5 of the third lens L3 to a thickness of the total track length TTL of the camera optical lens 10, which is beneficial to reasonably controlling the total track length TTL of the camera optical lens 10 within the range limited by the condition. More preferably, 0.03≤d5/TTL≤0.09.

In this embodiment, an object-side surface of the fourth lens L4 is convex in a paraxial region, an image-side surface of the fourth lens L4 is convex in the paraxial region, and the fourth lens L4 has a positive refractive power. In other optional embodiments, the object-side surface and the image-side surface of the fourth lens L4 may be arranged in other concave and convex arrangements, and the fourth lens L4 may have a negative refractive power.

Preferably, R7 represents a curvature radius of the object-side surface of the fourth lens L4, R8 represents a curvature radius of the image-side surface of the fourth lens L4, f4 represents a focal length of the fourth lens L4, f represents a focal length of the camera optical lens 10, d7 represents an on-axis thickness of the fourth lens L4, TTL represents a total track length of the camera optical lens 10, and the following conditions are satisfied:

$$0. \leq ( R 7 + R 8 ) / ( R 7 - R 8 ) \leq 0.9 \qquad ( 18 )$$

$$0.61 \leq f 4 / f \leq 2.69 \qquad ( 19 )$$

$$0.03 \leq d 7 / TTL \leq 0.27 \qquad ( 20 )$$

The condition (18) specifies a shape of the fourth lens L4, which can moderate the degree of deflection of the light passing through the fourth lens L4 within the range, so that the camera optical lens 10 has good imaging quality and low sensitivity. More preferably, the following condition is satisfied: 0.00≤(R7+R8)/(R7−R8)≤0.72. The condition (19) specifies a ratio of the focal length f4 of the fourth lens L4 to the focal length f of the camera optical lens 10, which reasonably allocates the focal length inside the camera optical lens 10, so that the camera optical lens 10 has good imaging quality and low sensitivity. More preferably, 0.98≤f4/f≤2.15. The condition (20) specifies a ratio of the on-axis thickness d7 of the fourth lens L4 to the total track length TTL of the camera optical lens 10, which can efficiently compress the total track length TTL of the camera optical lens 10 and realize the ultra-thin design of the camera optical lens 10 within the range of the condition. More preferably, 0.05≤d7/TTL≤0.21.

In this embodiment, an object-side surface of the fifth lens L5 is convex in a paraxial region, an image-side surface of the fifth lens L5 is concave in the paraxial region, and the fifth lens L5 has a positive refractive power. In other optional embodiments, the object-side surface and the image-side surface of the fifth lens L5 may be arranged in other concave and convex arrangements, and the fifth lens L5 may have a negative refractive power.

Preferably, R9 represents a curvature radius of the object-side surface of the fifth lens L5, R10 represents a curvature radius of the image-side surface of the fifth lens L5, f5 represents a focal length of the fifth lens L5, f represents a focal length of the camera optical lens 10, d9 represents an on-axis thickness of the fifth lens L5, TTL represents a total track length of the camera optical lens 10, and the following conditions are satisfied:

$$- 17.54 \leq ( R 9 + R 10 ) / ( R 9 - R 10 ) \leq - 1.95 \qquad ( 21 )$$

$$4.38 \leq f 5 / f \leq 45.6 \qquad ( 22 )$$

$$0.06 \leq d 9 / TTL \leq 0.36 \qquad ( 23 )$$

The condition (21) specifies a shape of the fifth lens L5, which is beneficial to improving the optical performance of the camera optical lens 10 within the limited range. More preferably, the following condition is satisfied: −10.96≤(R9+R10)/(R9−R10)≤−2.44. The condition (122) specifies a ratio of the focal length f5 of the fifth lens L5 to the focal length f of the camera optical lens 10, which is beneficial to improving the optical performance of the camera optical lens 10 within the range limited by the condition. More preferably, 7.01≤f5/f≤36.48. The condition (23) specifies a ratio of the on-axis thickness d9 of the fifth lens L5 to the total track length TTL of the camera optical lens 10, which is beneficial to realizing the ultra-thin design of the camera optical lens 10. More preferably, 0.10≤d9/TTL≤0.29.

In this embodiment, an object-side surface of the sixth lens L6 is convex in a paraxial region, an image-side surface of the sixth lens L6 is concave in the paraxial region, and the sixth lens L6 has a positive refractive power. In other optional embodiments, the object-side surface and the image-side surface of the sixth lens L6 may be arranged in other concave and convex arrangements, and the sixth lens L6 may have a negative refractive power.

Preferably, R11 represents a curvature radius of the object-side surface of the sixth lens L6, R12 represents a curvature radius of the image-side surface of the sixth lens L6, f6 represents a focal length of the sixth lens L6, f represents a focal length of the camera optical lens 10, d11 represents an on-axis thickness of the sixth lens L6, TTL represents a total track length of the camera optical lens 10, and the following conditions are satisfied:

$$- 5.98 \leq ( R 11 + R 12 ) / ( R 11 - R 12 ) \leq - 1 \text{.50} \qquad ( 24 )$$

$$0.92 \leq f 6 / f \leq 4.36 \qquad ( 25 )$$

$$0.02 \leq d 11 / TTL \leq 0.14 \qquad ( 26 )$$

The condition (24) specifies a shape of the sixth lens L6, which can moderate the off-axis aberration of the camera optical lens 10 generated during the ultra-thin and wide-angle design. More preferably, the following condition is satisfied: 3.74≤(R11+R12)/(R11−R12)≤−1.87. The condition (25) specifies a range of a ratio of the focal length f6 of the sixth lens L6 to the focal length f of the camera optical lens 10, which reasonably allocates the foal length inside the camera optical lens 10 within the range, so that the camera optical lens 10 has good imaging quality and low sensitivity. More preferably, 1.48≤f6/f≤3.49. The condition (26) specifies a range of a ratio of the on-axis thickness d6 of the sixth lens L6 to the total track length TTL of the camera optical lens 10, which is beneficial to realizing the ultra-thin design of the camera optical lens 10. More preferably, 0.03≤d11/TTL≤0.11.

Preferably, FNO refers to F number of the camera optical lens 10, which further satisfies the following condition:

$$FNO \leq 1.3 \qquad ( 27 )$$

The condition (27) specifies the F number of the aperture of the camera optical lens 10, which, within the range limited by the condition (27), can realize a large amount of light intake while the camera optical lens 10 is miniaturized, thus improving the range of the camera optical lens 10 and improving the anti-ambient light ability of the camera optical lens 10, and ensuring that the camera optical lens 10 has a good reception effect.

In this embodiment, the first lens L1 is made of glass, the second lens L2 is made of plastic, the third lens L3 is made of plastic, the fourth lens L4 is made of glass, the fifth lens L5 is made of plastic, and the sixth lens L6 is made of plastic. In other optional embodiments, the lenses may be made of other materials.

In this embodiment, an optical element such as an optical filter GF is provided between the sixth lens L6 and an image surface Si. The optical filter GF may be a glass cover plate or an optical filter (filter). As shown in FIG. 1, a first optical filter GF1 and a second optical filter GF2 are provided between the sixth lens L6 and the image surface Si. In other embodiments, the optical filter GF is made of glass. In other embodiments, the optical filter GF may be provided at other positions.

The camera optical lens 10 according to the present disclosure has good optical performance, a large aperture, miniaturization, and has good reception. According to the optical characteristics of the camera optical lens 10, the camera optical lens 10 is particularly suitable for use on a detection device such as an in-vehicle laser radar.

In the following, the camera optical lens 10 according to the present disclosure will be described with examples. The symbols recorded in each example are shown in table 1, and the units of the focal length, the on-axis distance, the curvature radius, the on-axis thickness, the inflexion points, and the arrest points are millimeters.

TTL refers to a total track length (an on-axis distance from the object-side surface of the first lens L1 to the image surface) in units of millimeters.

Preferably, an inflexion point and/or an arrest point may be provided on the object-side surface and/or the image-side surface of the lens, so as to meet high quality imaging requirements. The specific implementations can make reference to the following description.

FIG. 1 is a schematic structural diagram of the camera optical lens 10 according to a first embodiment. The following shows design data of the camera optical lens 10 according to a first embodiment of the present disclosure.

Table 1 lists the curvature radius R o, the on-axis thickness of each lens, the on-axis distance d between the lenses, the refractive index nd and the Abbe number vd of the object-side surface and the image-side surface of the first lens L1 to the sixth lens L6 constituting the camera optical lens 10 according to the first embodiment of the present disclosure. Table 2 illustrates a conic coefficient k and aspheric surface coefficients of the camera optical lens 10. It is noted that in this implementation, the units of the distance, the radius and the thickness are millimeters (mm).

TABLE 1

| | R | d | | nd | | vd | |
|---|---|---|---|---|---|---|---|
| S1 | ∞ | d0= | −5.313 | | | | |
| R1 | 22.867 | d1= | 1.000 | nd1 | 2.0007 | vd1 | 25.44 |
| R2 | 3.076 | d2= | 1.185 | | | | |
| R3 | −155.669 | d3= | 1.000 | nd2 | 1.6393 | vd2 | 23.35 |
| R4 | −6.249 | d4= | 0.473 | | | | |
| R5 | −13.695 | d5= | 1.310 | nd3 | 1.5131 | vd3 | 56.22 |
| R6 | 5.437 | d6= | 0.475 | | | | |
| R7 | 13.494 | d7= | 2.197 | nd4 | 2.0007 | vd4 | 25.44 |
| R8 | −6.495 | d8= | 1.412 | | | | |
| R9 | 11.686 | d9= | 2.749 | nd5 | 1.5131 | vd5 | 56.22 |
| R10 | 16.540 | d10= | 0.301 | | | | |
| R11 | 2.948 | d11= | 1.000 | nd6 | 1.6393 | vd6 | 23.35 |
| R12 | 6.650 | d12= | 1.071 | | | | |
| R13 | ∞ | d13= | 0.300 | ndg1 | 1.5233 | vg1 | 54.52 |
| R14 | ∞ | d14= | 1.946 | | | | |
| R15 | ∞ | d15= | 1.500 | ndg2 | 1.5233 | vg2 | 54.52 |
| R16 | ∞ | d16= | 0.115 | | | | |

The meanings of the symbols in the above table are listed as follows.
R: curvature radius of the optical surface, or central curvature radius in the case of a lens;
S1: aperture;
R1: curvature radius of the object-side surface of the first lens L1;
R2: curvature radius of the image-side surface of the first lens L1;
R3: curvature radius of the object-side surface of the second lens L2;
R4: curvature radius of the image-side surface of the second lens L2;
R5: curvature radius of the object-side surface of the third lens L3;
R6: curvature radius of the image-side surface of the third lens L3;
R7: curvature radius of the object-side surface of the fourth lens L4;
R8: curvature radius of the image-side surface of the fourth lens L4;
R9: curvature radius of the object-side surface of the fifth lens L5;
R10: curvature radius of the image-side surface of the fifth lens L5;
R11: curvature radius of the object-side surface of the sixth lens L6;
R12: curvature radius of the image-side surface of the sixth lens L6;
R15: curvature radius of the object-side surface of the first optical filter GF1;
R16: curvature radius of the image-side surface of the first optical filter GF1;
R17: curvature radius of the object-side surface of the second optical filter GF2;
R18: curvature radius of the image-side surface of the second optical filter GF2;
d: on-axis thickness of the lens or on-axis distance between adjacent lenses;
d0: on-axis distance from the aperture S1 to the object-side surface of the first lens L1;
d1: on-axis thickness of the first lens L1;
d2: on-axis distance from the image-side surface of the first lens L1 to the object-side surface of the second lens L2;
d3: on-axis thickness of the second lens L2;
d4: on-axis distance from the image-side surface of the second lens L2 to the object-side surface of the third lens L3;
d5: on-axis thickness of the third lens L3;
d6: on-axis distance from the image-side surface of the third lens L3 to the object-side surface of the fourth lens L4;
d7: on-axis thickness of the fourth lens L4;
d8: on-axis distance from the image-side surface of the fourth lens L4 to the object-side surface of the fifth lens L5;
d9: on-axis thickness of the fifth lens L5;
d10: on-axis distance from the image-side surface of the fifth lens L5 to the object-side surface of the sixth lens L6;
d11: on-axis thickness of the sixth lens L6;
d12: on-axis distance from the image-side surface of the sixth lens L6 to the object-side surface of the first optical filter GF1;
d13: on-axis thickness of the first optical filter GF1;
d14: on-axis distance from the image-side surface of the first optical filter GF1 to the object-side surface of the second optical filter GF2;
d15: on-axis thickness of the second optical filter GF2;
d16: on-axis distance from the image-side surface of the second optical filter GF2 to the image surface Si;
nd: refractive index of d-line (the d-line is green light with a wavelength of 550 nm);
nd1: refractive index of the first lens L1;
nd2: refractive index of the second lens L2;
nd3: refractive index of the third lens L3;
nd4: refractive index of the fourth lens L4;
nd5: refractive index of the fifth lens L5;
nd6: refractive index of the sixth lens L6;
ndg1: refractive index of the first optical filter GF1;
ndg2: refractive index of the second optical filter GF2;
vd: Abbe number;
vd1: Abbe number of the first lens L1;
vd2: Abbe number of the second lens L2;
vd3: Abbe number of the third lens L3;
vd4: Abbe number of the fourth lens L4;
vd5: Abbe number of the fifth lens L5;
vd6: Abbe number of the sixth lens L6;
vg1: Abbe number of the first optical filter GF1;
vg2: Abbe number of the second optical filter GF2.

TABLE 2

| | Conic coefficient | Aspheric surface coefficients | | | | |
|---|---|---|---|---|---|---|
| | k | A4 | A6 | A8 | A10 | A12 |
| R1 | / | / | / | / | / | / |
| R2 | / | / | / | / | / | / |
| R3 | −9.95000E+01 | 1.10220E−02 | 1.67540E−03 | −1.23620E−03 | 5.34150E−04 | −1.35540E−04 |
| R4 | 3.98699E+00 | 2.77220E−02 | −1.21440E−03 | −8.17420E−04 | 6.36050E−04 | −2.00260E−04 |
| R5 | 2.57042E+01 | 1.38870E−02 | −5.69370E−03 | 7.96450E−04 | 2.21080E−04 | −1.44640E−04 |
| R6 | 3.26335E+00 | −9.42560E−03 | −9.78890E−04 | 4.32470E−04 | −1.14210E−04 | 1.56670E−05 |
| R7 | / | / | / | / | / | / |
| R8 | / | / | / | / | / | / |
| R9 | 4.73653E+00 | −1.90320E−03 | −8.96340E−06 | −8.11080E−05 | 1.93540E−05 | −3.49910E−06 |
| R10 | −2.55203E+01 | −4.41890E−02 | 1.09320E−02 | −2.16650E−03 | 3.17760E−04 | −3.31930E−05 |
| R11 | −9.17298E+00 | 7.40320E−03 | −1.01970E−02 | 3.87960E−03 | −1.06450E−03 | 2.05440E−04 |
| R12 | 1.71778E+00 | 4.58350E−03 | −6.06640E−03 | 1.35840E−03 | −1.97850E−04 | 1.86720E−05 |
| | Conic coefficient | Aspheric surface coefficients | | | | |
| | k | A14 | A16 | A18 | A20 | / |
| R1 | / | / | / | / | / | / |
| R2 | / | / | / | / | / | / |
| R3 | −9.95000E+01 | 1.99670E−05 | −1.55100E−06 | 4.74150E−08 | 0.00000E+00 | / |
| R4 | 3.98699E+00 | 3.44460E−05 | −3.02680E−06 | 1.00760E−07 | 0.00000E+00 | / |
| R5 | 2.57042E+01 | 3.42510E−05 | −4.18840E−06 | 2.59760E−07 | −6.43500E−09 | / |
| R6 | 3.26335E+00 | −1.05640E−06 | 0.00000E+00 | 0.00000E+00 | 0.00000E+00 | / |
| R7 | / | / | / | / | / | / |
| R8 | / | / | / | / | / | / |
| R9 | 4.73653E+00 | 3.31800E−07 | −1.42450E−08 | 0.00000E+00 | 0.00000E+00 | / |
| R10 | −2.55203E+01 | 2.28520E−06 | −9.19120E−08 | 1.61420E−09 | 0.00000E+00 | / |
| R11 | −9.17298E+00 | −2.68300E−05 | 2.23650E−06 | −1.06660E−07 | 2.19640E−09 | / |
| R12 | 1.71778E+00 | −1.08710E−06 | 3.45920E−08 | −4.57720E−10 | 0.00000E+00 | / |

It should be noted that an aspheric surface of each lens surface in this embodiment uses the aspheric surfaces shown in the above condition (27). However, the specific form of the condition (27) below is only an example, and the present disclosure is not limited to the aspherical polynomials form shown in the condition (27).

$$y = ( {c}^{2} / r ) / [ 1 + {\{ 1 - ( k + 1 ) ( {c}^{2} / {r}^{2} ) \}}^{1 / 2} ] + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 27 )$$

k is a conic coefficient, and A4, A6, A8, A10, A12, A14, A16, A18 and A20 are aspheric surface coefficients. c is a curvature at the center of the optical surface, r is a vertical distance between the point on an aspheric curve and the optical axis, and z is an aspheric depth (a vertical distance between the point on the aspheric surface having a distance of r from the optical axis, and a tangent plane tangent to a vertex on the optical axis of an aspheric surface).

Table 3 and Table 4 show design data of inflexion points and arrest points of each lens of the camera optical lens 10 according to the first embodiment of the present disclosure. Herein, PIR1 and PIR2 represent the object-side surface and the image-side surface of the first lens L1, P2R1 and P2R2 represent the object-side surface and the image-side surface of the second lens L2, P3R1 and P3R2 represent the object-side surface and the image-side surface of the third lens L3, P4R1 and P4R2 represent the object-side surface and the image-side surface of the fourth lens L4, P5R1 and P5R2 represent the object-side surface and the image-side surface of the fifth lens L5, and P6R1 and P6R2 represent the object-side surface and the image-side surface of the sixth lens L6. The data in the column named “inflexion point position” refers to vertical distances from inflexion points arranged on each lens surface to the optical axis of the camera optical lens 10. The data in the column named “arrest point position” refers to vertical distances from arrest points arranged on each lens surface to the optical axis of the camera optical lens 10.

TABLE 3

| | Number(s) of | Inflexion point | Inflexion point |
|---|---|---|---|
| | inflexion points | position 1 | position 2 |
| P1R1 | / | / | / |
| P1R2 | / | / | / |
| P2R1 | 2 | 0.225 | 2.555 |
| P2R2 | 1 | 0.775 | / |
| P3R1 | / | / | / |
| P3R2 | 1 | 1.885 | / |
| P4R1 | / | / | / |
| P4R2 | / | / | / |
| P5R1 | 1 | 1.625 | / |
| P5R2 | 1 | 0.355 | / |
| P6R1 | 1 | 1.115 | / |
| P6R2 | 1 | 1.315 | / |

TABLE 4

| | Number(s) of arrest points | Arrest point position |
|---|---|---|
| P1R1 | / | / |
| P1R2 | / | / |
| P2R1 | 1 | 0.375 |
| P2R2 | 1 | 1.385 |
| P3R1 | / | / |
| P3R2 | / | / |
| P4R1 | / | / |
| P4R2 | / | / |
| P5R1 | 1 | 2.385 |
| P5R2 | 1 | 0.625 |
| P6R1 | 1 | 2.055 |
| P6R2 | 1 | 2.165 |

In addition, in the following table 25, the values corresponding to the various parameters in the first embodiment and the parameters specified in the condition are listed.

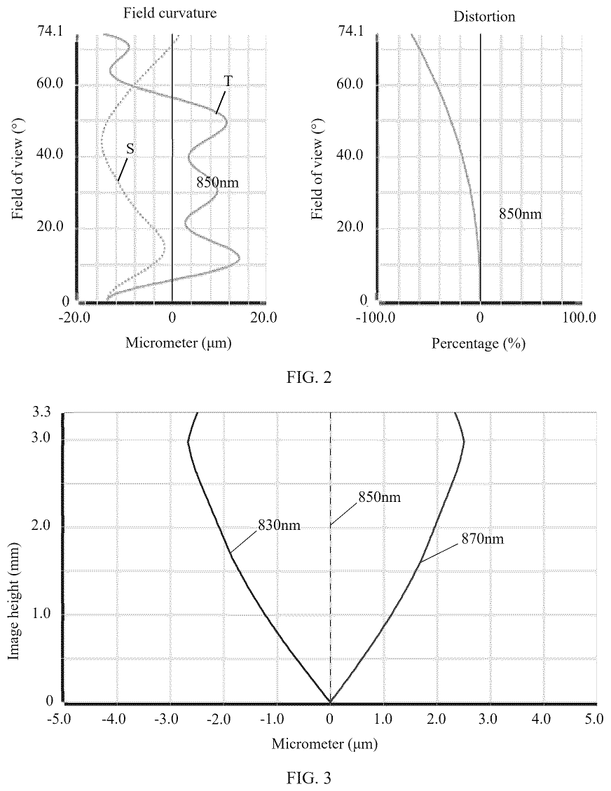

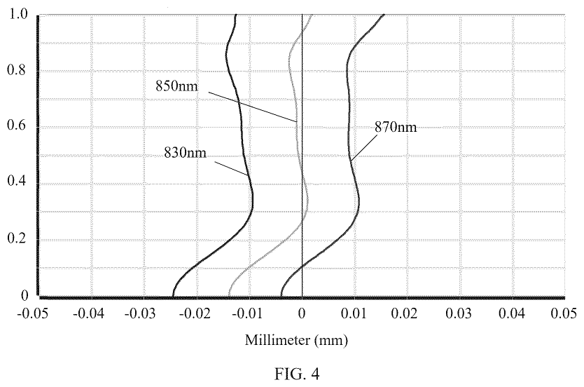

FIG. 2 shows a field curvature and a distortion after light with a wavelength of 850 nm passes through the camera optical lens 10 in the first embodiment. FIG. 3 shows a lateral color after light with wavelengths of 830 nm, 850 nm and 870 nm pass through the camera optical lens 10 in the first embodiment. FIG. 4 is a schematic diagram of a longitudinal aberration after light with wavelengths of 830 nm, 850 nm and 870 nm pass through the camera optical lens 10 in the first embodiment.

As shown in Table 25, the first embodiment satisfies the various conditions.

In this embodiment, an entrance pupil diameter (ENPD) of the camera optical lens 10 is 2.237 mm, an image height (IH) of 1.0H is 3.300 mm, and a field of view (FOV) in a diagonal direction is 148.20°. Thus, the camera optical lens 10 meets the design requirement for large aperture, and miniaturization, the on-axis and off-axis aberrations are sufficiently corrected, thereby achieving excellent optical performance.

### Second Embodiment

FIG. 5 is a schematic structural diagram of the camera optical lens 20 according to the second embodiment. The second embodiment is substantially the same as the first embodiment, and the meanings of the symbols in the second embodiment are the same as the meanings of the symbols in the first embodiment. In the following, only differences are described.

Table 5 and Table 6 show design data of the camera optical lens 20 in the second embodiment of the present disclosure.

TABLE 5

| | R | d | | nd | | vd | |
|---|---|---|---|---|---|---|---|
| S1 | ∞ | d0= | −6.452 | | | | |
| R1 | 34.983 | d1= | 2.289 | nd1 | 2.0007 | vd1 | 25.44 |
| R2 | 2.990 | d2= | 1.761 | | | | |
| R3 | −123.315 | d3= | 0.550 | nd2 | 1.6393 | vd2 | 23.35 |
| R4 | −6.330 | d4= | 0.396 | | | | |
| R5 | −11.344 | d5= | 0.924 | nd3 | 1.5131 | vd3 | 56.22 |
| R6 | 9.407 | d6= | 0.387 | | | | |
| R7 | 9.177 | d7= | 1.690 | nd4 | 2.0007 | vd4 | 25.44 |
| R8 | −9.101 | d8= | 0.500 | | | | |
| R9 | 9.033 | d9= | 2.021 | nd5 | 1.5131 | vd5 | 56.22 |
| R10 | 13.998 | d10= | 0.271 | | | | |
| R11 | 2.942 | d11= | 1.444 | nd6 | 1.6393 | vd6 | 23.35 |
| R12 | 5.899 | d12= | 0.828 | | | | |
| R13 | ∞ | d13= | 0.300 | ndg1 | 1.5233 | vg1 | 54.52 |
| R14 | ∞ | d14= | 1.764 | | | | |
| R15 | ∞ | d15= | 0.500 | ndg2 | 1.5233 | vg2 | 54.52 |
| R16 | ∞ | d16= | 0.115 | | | | |

TABLE 6

| | Conic coefficient | Aspheric surface coefficients | | | | |
|---|---|---|---|---|---|---|
| | k | A4 | A6 | A8 | A10 | A12 |
| R1 | / | / | / | / | / | / |
| R2 | / | / | / | / | / | / |
| R3 | 2.48119E+03 | 8.52470E−03 | 1.69910E−03 | −1.19230E−03 | 5.34480E−04 | −1.36390E−04 |
| R4 | 4.28946E+00 | 2.59980E−02 | −1.00370E−03 | −7.96910E−04 | 6.34640E−04 | −2.00770E−04 |
| R5 | 2.19967E+01 | 1.48400E−02 | −6.20670E−03 | 8.00990E−04 | 2.27920E−04 | −1.43860E−04 |
| R6 | 4.68935E+00 | −7.86660E−03 | −9.24500E−04 | 4.20010E−04 | −1.14140E−04 | 1.64000E−05 |
| R7 | / | / | / | / | / | / |
| R8 | / | / | / | / | / | / |
| R9 | 1.60540E+00 | −2.31260E−03 | −1.41080E−04 | −1.00970E−04 | 1.76340E−05 | −3.58130E−06 |
| R10 | −6.95224E+01 | −4.45160E−02 | 1.08570E−02 | −2.17540E−03 | 3.17430E−04 | −3.31770E−05 |
| R11 | −1.09234E+01 | 6.01550E−03 | −1.04230E−02 | 3.86660E−03 | −1.06330E−03 | 2.05730E−04 |
| R12 | 2.14541E+00 | 5.54730E−03 | −6.03770E−03 | 1.35890E−03 | −1.98220E−04 | 1.86280E−05 |
| | Conic coefficient | Aspheric surface coefficients | | | | |
| | k | A14 | A16 | A18 | A20 | / |
| R1 | / | / | / | / | / | / |
| R2 | / | / | 1 | / | / | / |
| R3 | 2.48119E+03 | 1.97790E−05 | −1.57770E−06 | 4.47250E−08 | −1.26490E−10 | / |
| R4 | 4.28946E+00 | 3.43220E−05 | −3.04960E−06 | 9.70320E−08 | −1.10650E−09 | / |
| R5 | 2.19967E+01 | 3.42610E−05 | −4.20080E−06 | 2.59160E−07 | −5.44220E−09 | / |
| R6 | 4.68935E+00 | −8.89240E−07 | 1.87960E−08 | 1.13870E−10 | −5.32650E−10 | / |
| R7 | / | / | / | / | / | / |
| R8 | / | / | / | / | / | / |
| R9 | 1.60540E+00 | 3.33960E−07 | −1.32560E−08 | 1.25530E−10 | −7.53450E−13 | / |
| R10 | −6.95224E+01 | 2.28850E−06 | −9.16100E−08 | 1.61730E−09 | −3.36030E−12 | / |
| R11 | −1.09234E+01 | −2.68070E−05 | 2.23630E−06 | −1.06970E−07 | 2.18520E−09 | / |
| R12 | 2.14541E+00 | −1.08730E−06 | 3.50650E−08 | −4.22720E−10 | −1.00660E−11 | / |

Table 7 and table 8 show design data of inflexion points and arrest points of each lens of the camera optical lens 20 in the second embodiment of the present disclosure.

TABLE 7

| | Number(s) of | Inflexion point | Inflexion point |
|---|---|---|---|
| | inflexion points | position 1 | position 2 |
| P1R1 | / | / | / |
| P1R2 | / | / | / |
| P2R1 | 2 | 0.285 | 2.095 |
| P2R2 | 2 | 0.795 | 2.095 |
| P3R1 | / | / | / |
| P3R2 | 1 | 1.055 | / |
| P4R1 | / | / | / |
| P4R2 | / | / | / |
| P5R1 | 1 | 1.495 | / |
| P5R2 | 1 | 0.375 | / |
| P6R1 | 1 | 1.025 | / |
| P6R2 | 1 | 1.505 | / |

TABLE 8

| | Number(s) of arrest points | Arrest point position |
|---|---|---|
| P1R1 | / | / |
| P1R2 | / | / |
| P2R1 | 1 | 0.475 |
| P2R2 | 1 | 1.425 |
| P3R1 | / | / |
| P3R2 | 1 | 1.845 |
| P4R1 | / | / |
| P4R2 | / | / |
| P5R1 | 1 | 2.175 |
| P5R2 | 1 | 0.665 |
| P6R1 | 1 | 1.865 |
| P6R2 | 1 | 2.695 |

In addition, in the following table 25, the values corresponding to the various parameters in the second embodiment and the parameters specified in the condition are listed.

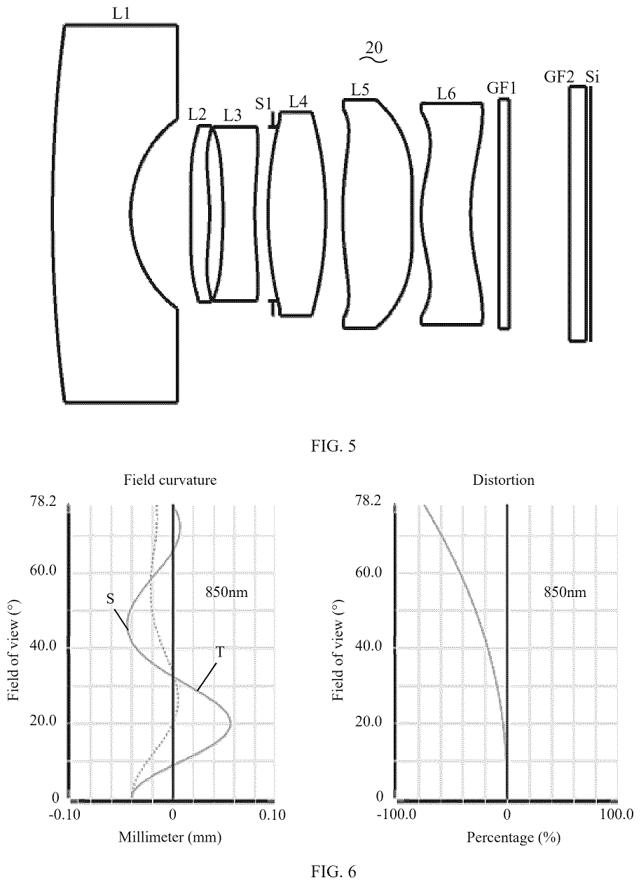

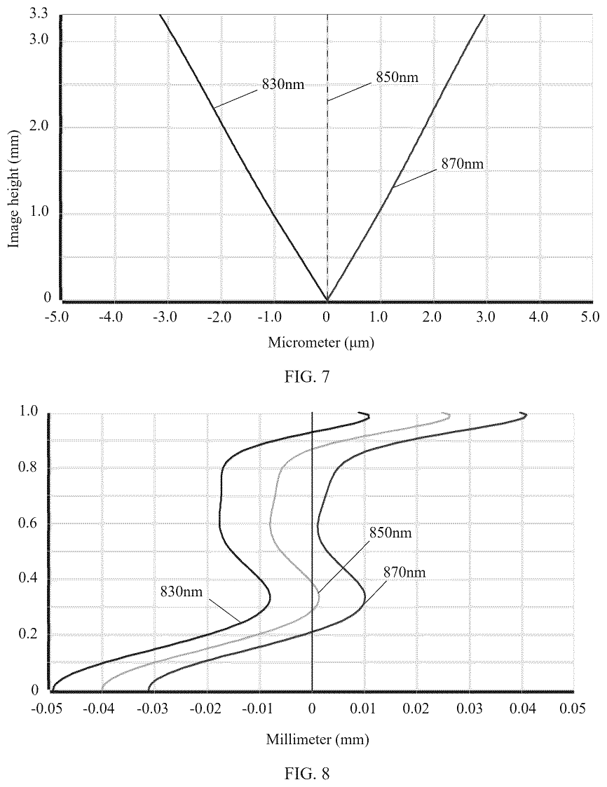

FIG. 6 shows a field curvature and a distortion after light with a wavelength of 850 nm passes through the camera optical lens 20 in the second embodiment. FIG. 7 shows a lateral color after light with wavelengths of 830 nm, 850 nm and 870 nm pass through the camera optical lens 20 in the second embodiment. FIG. 8 is a schematic diagram of a longitudinal aberration and a lateral color after light with wavelengths of 830 nm, 850 nm and 870 nm pass through the camera optical lens 20 in the second embodiment.

As shown in Table 25, the second embodiment satisfies the various conditions.

In this Embodiment, an entrance pupil diameter (ENPD) of the camera optical lens 20 is 2.112 mm, an image height (IH) of 1.0H is 3.300 mm, and a field of view (FOV) in a diagonal direction is 156.40°. Thus, the camera optical lens 20 meets the design requirement for large aperture, and miniaturization, the on-axis and off-axis aberrations are sufficiently corrected, thereby achieving excellent optical performance.

### Third Embodiment

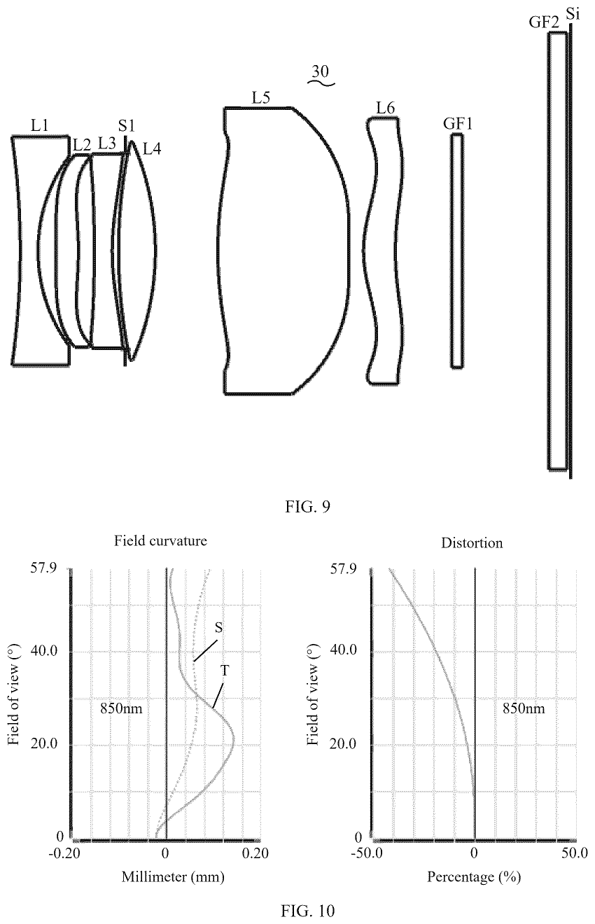

FIG. 9 is a schematic structural diagram of the camera optical lens 30 according to the third embodiment. The third embodiment is substantially the same as the first embodiment, and the meanings of the symbols in the third embodiment are the same as the meanings of the symbols in the first embodiment. In the following, only differences are described.

The object-side surface of the first lens L1 is concave in the paraxial region.

Table 9 and Table 10 show design data of the camera optical lens 30 in the third embodiment of the present disclosure.

TABLE 9

| | R | d | | nd | | vd | |
|---|---|---|---|---|---|---|---|
| S1 | ∞ | d0= | −2.982 | | | | |
| R1 | −18.174 | d1= | 0.500 | nd1 | 2.1042 | vd1 | 17.02 |
| R2 | 3.752 | d2= | 0.514 | | | | |
| R3 | −114.648 | d3= | 0.644 | nd2 | 1.6393 | vd2 | 23.35 |
| R4 | −6.922 | d4= | 0.458 | | | | |
| R5 | −17.754 | d5= | 0.501 | nd3 | 1.5131 | vd3 | 56.22 |
| R6 | 5.606 | d6= | 0.181 | | | | |
| R7 | 12.019 | d7= | 1.056 | nd4 | 2.0007 | vd4 | 25.44 |
| R8 | −6.310 | d8= | 1.781 | | | | |
| R9 | 9.142 | d9= | 3.733 | nd5 | 1.5131 | vd5 | 56.22 |
| R10 | 18.622 | d10= | 0.415 | | | | |
| R11 | 2.725 | d11= | 0.915 | nd6 | 1.6393 | vd6 | 23.35 |
| R12 | 7.105 | d12= | 1.604 | | | | |
| R13 | ∞ | d13= | 0.300 | ndg1 | 1.5233 | vg1 | 54.52 |
| R14 | ∞ | d14= | 2.479 | | | | |
| R15 | ∞ | d15= | 0.500 | ndg2 | 1.5233 | vg2 | 54.52 |
| R16 | ∞ | d16= | 0.115 | | | | |

TABLE 10

| | Conic coefficient | Aspheric surface coefficients | | | | |
|---|---|---|---|---|---|---|
| | k | A4 | A6 | A8 | A10 | A12 |
| R1 | / | / | / | / | / | / |
| R2 | / | / | / | / | / | / |
| R3 | 2.08210E+03 | 1.29170E−02 | 1.60770E−03 | −1.21860E−03 | 5.37440E−04 | −1.35350E−04 |
| R4 | 3.98957E+00 | 2.74370E−02 | −1.01320E−03 | −8.36240E−04 | 6.31050E−04 | −2.00440E−04 |
| R5 | 1.74098E+01 | 1.35630E−02 | −5.78920E−03 | 8.16990E−04 | 2.23510E−04 | −1.44650E−04 |
| R6 | 3.16262E+00 | −1.00460E−02 | −1.00150E−03 | 4.35360E−04 | −1.13040E−04 | 1.58950E−05 |
| R7 | / | / | / | / | / | / |
| R8 | / | / | / | / | / | / |
| R9 | 5.88518E+00 | −1.36230E−03 | −6.57390E−06 | −8.24010E−05 | 1.92220E−05 | −3.51220E−06 |
| R10 | −2.75681E+01 | −4.40320E−02 | 1.09510E−02 | −2.16550E−03 | 3.17810E−04 | −3.31910E−05 |
| R11 | −7.43833E+00 | 7.90160E−03 | −1.02400E−02 | 3.87310E−03 | −1.06450E−03 | 2.05530E−04 |
| R12 | 1.94814E+00 | 4.30810E−03 | −5.98700E−03 | 1.36410E−03 | −1.97550E−04 | 1.86880E−05 |
| | Conic coefficient | Aspheric surface coefficients | | | | |
| | k | A14 | A16 | A18 | A20 | / |
| R1 | / | / | / | / | / | / |
| R2 | / | / | / | / | / | / |
| R3 | 2.08210E+03 | 1.99530E−05 | −1.55370E−06 | 4.76930E−08 | 2.45490E−10 | / |
| R4 | 3.98957E+00 | 3.45420E−05 | −3.00320E−06 | 1.04690E−07 | 5.19130E−10 | / |
| R5 | 1.74098E+01 | 3.42040E−05 | −4.19110E−06 | 2.61700E−07 | −5.52920E−09 | / |
| R6 | 3.16262E+00 | −1.02240E−06 | 3.86990E−09 | 2.23940E−10 | −5.15370E−11 | / |
| R7 | / | / | / | / | / | / |
| R8 | / | / | / | / | / | / |
| R9 | 5.88518E+00 | 3.30390E−07 | −1.43430E−08 | −3.73730E−12 | 2.49640E−12 | / |
| R10 | −2.75681E+01 | 2.28570E−06 | −9.18510E−08 | 1.61820E−09 | −2.58030E−13 | / |
| R11 | −7.43833E+00 | −2.68190E−05 | 2.23730E−06 | −1.06640E−07 | 2.19580E−09 | / |
| R12 | 1.94814E+00 | −1.08550E−06 | 3.47950E−08 | −4.35410E−10 | 1.58170E−12 | / |

Table 11 and Table 12 show design data of inflexion points and arrest points of each lens of the camera optical lens 30 in the third embodiment of the present disclosure.

TABLE 11

| | Number(s) of | Inflexion point | Inflexion point |
|---|---|---|---|
| | inflexion points | position 1 | position 2 |
| P1R1 | / | / | / |
| P1R2 | / | / | / |
| P2R1 | 1 | 0.245 | / |
| P2R2 | 1 | 0.715 | / |
| P3R1 | 1 | 1.985 | / |
| P3R2 | 2 | 1.475 | 2.455 |
| P4R1 | / | / | / |
| P4R2 | / | / | / |
| P5R1 | 1 | 1.985 | / |
| P5R2 | 2 | 0.335 | 3.605 |
| P6R1 | 2 | 1.155 | 2.905 |
| P6R2 | 2 | 1.285 | 2.845 |

TABLE 12

| | Number(s) of arrest | Arrest point position | Arrest point position |
|---|---|---|---|
| | points | 1 | 2 |
| P1R1 | / | / | / |
| PIR2 | / | / | / |
| P2R1 | 1 | 0.405 | / |
| P2R2 | 1 | 1.275 | / |
| P3R1 | 1 | 2.255 | / |
| P3R2 | / | / | / |
| P4R1 | / | / | / |
| P4R2 | / | / | / |
| P5R1 | 1 | 2.685 | / |
| P5R2 | 1 | 0.585 | / |
| P6R1 | 2 | 2.135 | 3.235 |
| P6R2 | 2 | 2.155 | 3.165 |

In addition, in the following table 25, the values corresponding to the various parameters in the third embodiment and the parameters specified in the condition are listed.

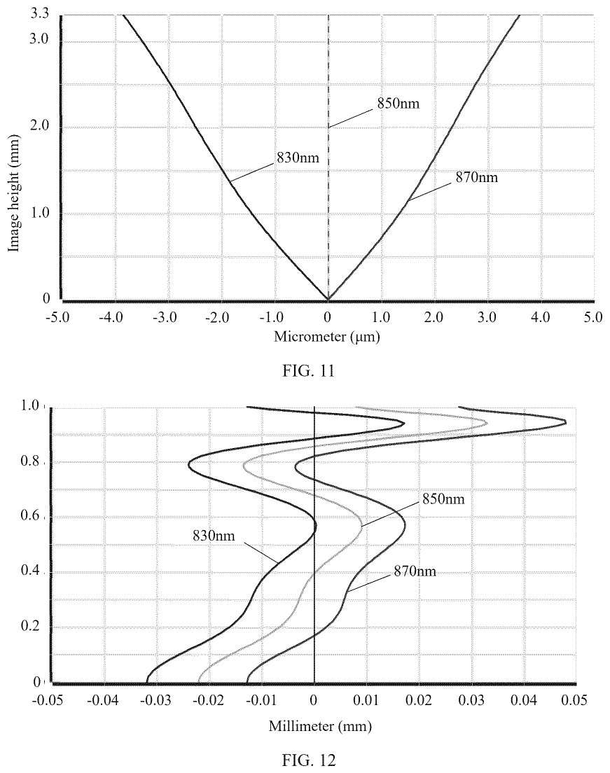

FIG. 10 shows a field curvature and a distortion after light with a wavelength of 850 nm passes through the camera optical lens 30 in the third embodiment. FIG. 11 shows a lateral color after light with wavelengths of 830 nm, 850 nm and 870 nm pass through the camera optical lens 30 in the third embodiment. FIG. 12 is a schematic diagram of a longitudinal aberration and a lateral color after light with wavelengths of 830 nm, 850 nm and 870 nm pass through the camera optical lens 30 in the third embodiment.

As shown in Table 25, the third embodiment satisfies the various conditions.

In this embodiment, an entrance pupil diameter (ENPD) of the camera optical lens 30 is 2.750 mm, an image height (IH) of 1.0H is 3.300 mm, and a field of view (FOV) in a diagonal direction is 115.88°. Thus, the camera optical lens 30 meets the design requirement for large aperture, and miniaturization, the on-axis and off-axis aberrations are sufficiently corrected, thereby achieving excellent optical performance.

### Fourth Embodiment

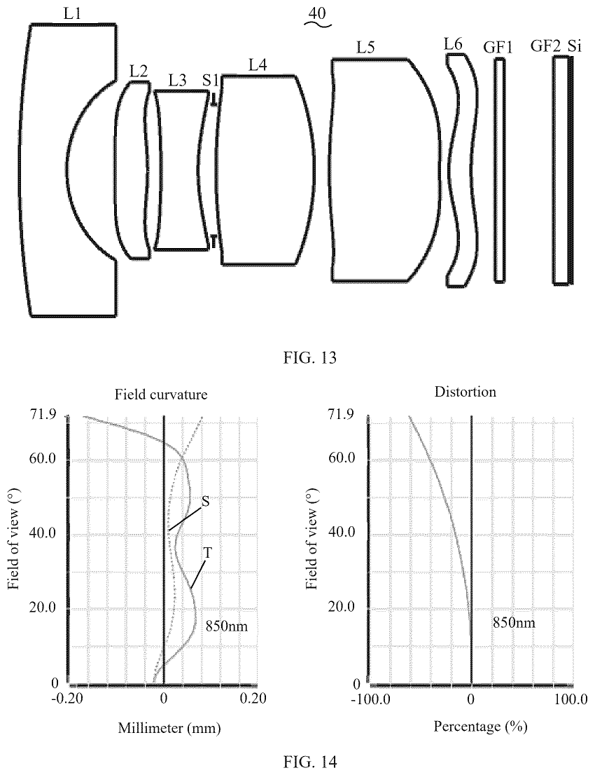

FIG. 13 is a schematic structural diagram of the camera optical lens 40 according to the fourth embodiment. The fourth embodiment is substantially the same as the first embodiment, and the meanings of the symbols in the fourth embodiment are the same as the meanings of the symbols in the first embodiment. In the following, only differences are described.

Table 13 and Table 14 show design data of the camera optical lens 40 in the fourth embodiment of the present disclosure.

TABLE 13

| | R | d | | nd | | vd | |
|---|---|---|---|---|---|---|---|
| S1 | ∞ | d0= | −6.505 | | | | |
| R1 | 24.046 | d1= | 1.591 | nd1 | 1.7130 | vd1 | 53.87 |
| R2 | 2.961 | d2= | 1.613 | | | | |
| R3 | −88.810 | d3= | 1.089 | nd2 | 1.6393 | vd2 | 23.35 |
| R4 | −5.920 | d4= | 0.448 | | | | |
| R5 | −13.331 | d5= | 1.244 | nd3 | 1.5131 | vd3 | 56.22 |
| R6 | 5.149 | d6= | 0.598 | | | | |
| R7 | 14.872 | d7= | 3.280 | nd4 | 2.0007 | vd4 | 25.44 |
| R8 | −6.437 | d8= | 0.500 | | | | |
| R9 | 12.291 | d9= | 3.693 | nd5 | 1.5131 | vd5 | 56.22 |
| R10 | 15.455 | d10= | 0.307 | | | | |
| R11 | 2.880 | d11= | 0.741 | nd6 | 1.6393 | vd6 | 23.35 |
| R12 | 6.663 | d12= | 0.808 | | | | |
| R13 | ∞ | d13= | 0.300 | ndg1 | 1.5233 | vg1 | 54.52 |
| R14 | ∞ | d14= | 1.663 | | | | |
| R15 | ∞ | d15= | 0.500 | ndg2 | 1.5233 | vg2 | 54.52 |
| R16 | ∞ | d16= | 0.115 | | | | |

TABLE 14

| | Conic coefficient | Aspheric surface coefficients | | | | |
|---|---|---|---|---|---|---|
| | k | A4 | A6 | A8 | A10 | A12 |
| R1 | / | / | / | / | / | / |
| R2 | / | / | / | / | / | / |
| R3 | 1.03093E+03 | 9.66490E−03 | 1.67020E−03 | −1.23320E−03 | 5.35410E−04 | −1.35390E−04 |
| R4 | 4.08506E+00 | 2.68380E−02 | −1.23620E−03 | −8.27870E−04 | 6.39020E−04 | −2.00300E−04 |
| R5 | 2.35605E+01 | 1.49380E−02 | −5.67760E−03 | 7.89940E−04 | 2.18240E−04 | −1.44860E−04 |
| R6 | 3.20604E+00 | −9.77940E−03 | −1.02740E−03 | 4.23600E−04 | −1.16810E−04 | 1.49510E−05 |
| R7 | / | / | / | / | / | / |
| R8 | / | / | / | / | / | / |
| R9 | 6.25691E+00 | −2.00420E−03 | 8.72700E−06 | −7.74630E−05 | 1.93350E−05 | −3.48300E−06 |
| R10 | −2.54785E+01 | −4.40940E−02 | 1.09360E−02 | −2.16260E−03 | 3.17680E−04 | −3.32010E−05 |
| R11 | −9.15452E+00 | 7.28460E−03 | −1.02470E−02 | 3.87960E−03 | −1.06430E−03 | 2.05480E−04 |
| R12 | 1.33668E+00 | 4.50780E−03 | −6.06890E−03 | 1.35990E−03 | −1.97910E−04 | 1.86910E−05 |
| | Conic coefficient | Aspheric surface coefficients | | | | |
| | k | A14 | A16 | A18 | A20 | / |
| R1 | / | / | / | / | / | / |
| R2 | / | / | / | / | / | / |
| R3 | 1.03093E+03 | 1.99940E−05 | −1.54700E−06 | 4.77430E−08 | 2.40140E−11 | / |
| R4 | 4.08506E+00 | 3.44720E−05 | −3.01420E−06 | 1.01060E−07 | −2.68210E−10 | / |
| R5 | 2.35605E+01 | 3.42150E−05 | −4.19750E−06 | 2.59800E−07 | −6.40180E−09 | / |
| R6 | 3.20604E+00 | −1.23990E−06 | 1.89450E−08 | 2.06660E−09 | 1.27100E−09 | / |
| R7 | / | / | / | / | / | / |
| R8 | / | / | | / | / | / |
| R9 | 6.25691E+00 | 3.28780E−07 | −1.43590E−08 | 2.09920E−11 | 1.53230E−11 | / |
| R10 | −2.54785E+01 | 2.28620E−06 | −9.17750E−08 | 1.62690E−09 | −7.27470E−13 | / |
| R11 | −9.15452E+00 | −2.68300E−05 | 2.23750E−06 | −1.06650E−07 | 2.19760E−09 | / |
| R12 | 1.33668E+00 | −1.08570E−06 | 3.48250E−08 | −4.46680E−10 | −7.35760E−13 | / |

Table 15 and Table 16 show design data of inflexion points and arrest points of each lens of the camera optical lens 40 in the fourth embodiment of the present disclosure.

TABLE 15

| | Number(s) of | Inflexion point | Inflexion point |
|---|---|---|---|
| | inflexion points | position 1 | position 2 |
| P1R1 | / | / | / |
| P1R2 | / | / | / |
| P2R1 | 1 | 0.315 | / |
| P2R2 | 2 | 0.835 | 2.315 |
| P3R1 | / | / | / |
| P3R2 | / | / | / |
| P4R1 | / | / | / |
| P4R2 | / | / | / |
| P5R1 | 1 | 1.635 | / |
| P5R2 | 1 | 0.365 | / |
| P6R1 | 1 | 1.105 | / |
| P6R2 | 2 | 1.295 | 3.355 |

TABLE 16

| | Number(s) of arrest points | Arrest point position 1 |
|---|---|---|
| P1R1 | / | / |
| P1R2 | / | / |
| P2R1 | 1 | 0.535 |
| P2R2 | 1 | 1.515 |
| P3R1 | / | / |
| P3R2 | / | / |
| P4R1 | / | / |
| P4R2 | / | / |
| P5R1 | 1 | 2.425 |
| P5R2 | 1 | 0.645 |
| P6R1 | 1 | 2.035 |
| P6R2 | 1 | 2.135 |

In addition, in the following table 25, the values corresponding to the various parameters in the fourth embodiment and the parameters specified in the condition are listed.

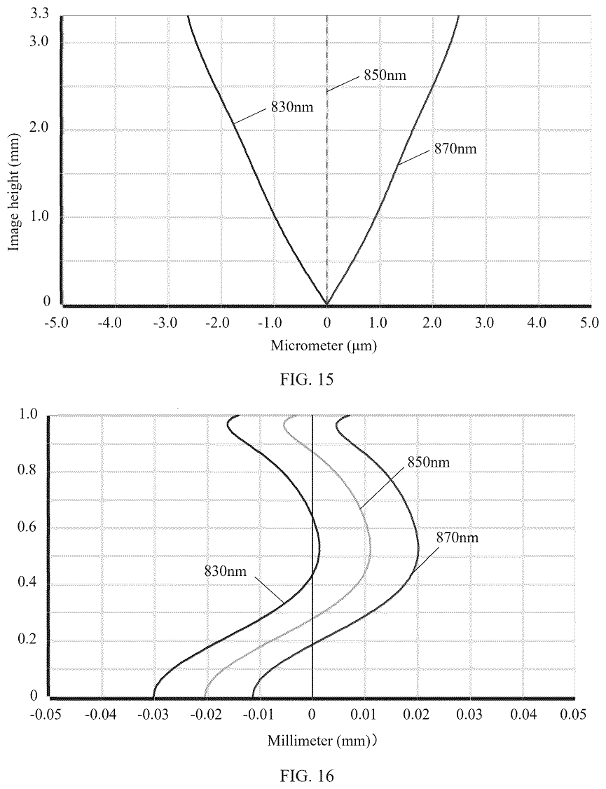

FIG. 14 shows a field curvature and a distortion after light with a wavelength of 850 nm passes through the camera optical lens 40 in the fourth embodiment. FIG. 15 shows a lateral color after light with wavelengths of 830 nm, 850 nm and 870 nm pass through the camera optical lens 40 in the fourth embodiment. FIG. 16 is a schematic diagram of a longitudinal aberration and a lateral color after light with wavelengths of 830 nm, 850 nm and 870 nm pass through the camera optical lens 40 in the fourth embodiment.

As shown in Table 25, the fourth embodiment satisfies the various conditions.

In this embodiment, an entrance pupil diameter (ENPD) of the camera optical lens 40 is 2.157 mm, an image height (IH) of 1.0H is 3.300 mm, and a field of view (FOV) in a diagonal direction is 143.88°. Thus, the camera optical lens 40 meets the design requirement for large aperture, and miniaturization, the on-axis and off-axis aberrations are sufficiently corrected, thereby achieving excellent optical performance.

### Fifth Embodiment

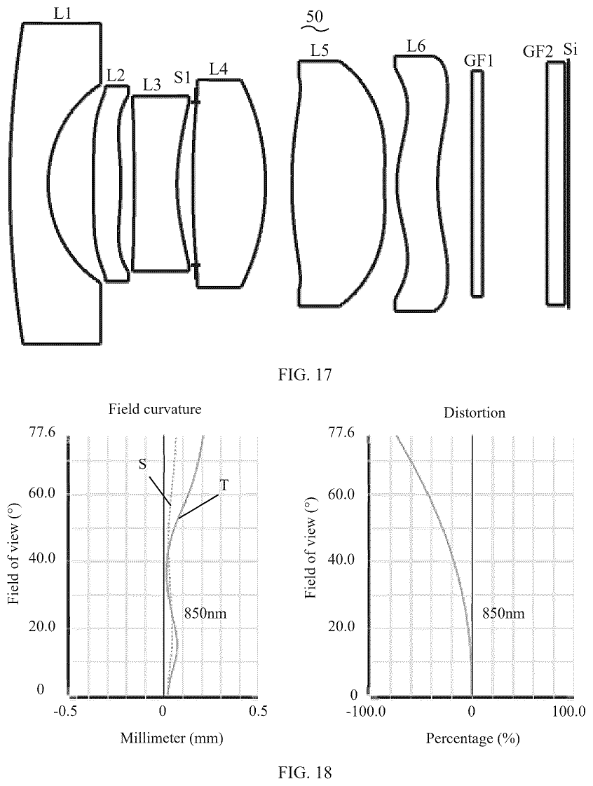

FIG. 17 is a schematic structural diagram of the camera optical lens 50 according to the fifth embodiment. The fifth embodiment is substantially the same as the first embodiment, and the meanings of the symbols in the fifth embodiment are the same as the meanings of the symbols in the first embodiment. In the following, only differences are described.

Table 17 and Table 18 show design data of the camera optical lens 50 in the fifth embodiment of the present disclosure.

TABLE 17

| | R | d | | nd | | vd | |
|---|---|---|---|---|---|---|---|
| S1 | ∞ | d0= | −5.321 | | | | |
| R1 | 24.301 | d1= | 1.090 | nd1 | 2.0007 | vd1 | 25.44 |
| R2 | 3.087 | d2= | 1.305 | | | | |
| R3 | −139.723 | d3= | 0.788 | nd2 | 1.6393 | vd2 | 23.35 |
| R4 | −6.393 | d4= | 0.372 | | | | |
| R5 | −25.991 | d5= | 1.228 | nd3 | 1.5131 | vd3 | 56.22 |
| R6 | 5.205 | d6= | 0.455 | | | | |
| R7 | 23.063 | d7= | 2.080 | nd4 | 2.0007 | vd4 | 25.44 |
| R8 | −5.793 | d8= | 0.745 | | | | |
| R9 | 10.100 | d9= | 2.654 | nd5 | 1.5131 | vd5 | 56.22 |
| R10 | 15.404 | d10= | 0.353 | | | | |
| R11 | 2.893 | d11= | 1.173 | nd6 | 1.6393 | vd6 | 23.35 |
| R12 | 5.902 | d12= | 0.978 | | | | |
| R3 | ∞ | d13= | 0.300 | ndg1 | 1.5233 | vg1 | 54.52 |
| R14 | ∞ | d14= | 1.852 | | | | |
| R15 | ∞ | d15= | 0.500 | ndg2 | 1.5233 | vg2 | 54.52 |
| R16 | ∞ | d16= | 0.115 | | | | |

TABLE 18

| | Conic coefficient | Aspheric surface coefficients | | | | |
|---|---|---|---|---|---|---|
| | k | A4 | A6 | A8 | A10 | A12 |
| R1 | / | / | / | / | / | / |
| R2 | / | / | / | / | / | / |
| R3 | 2.50961E+03 | 9.75380E−03 | 1.66600E−03 | −1.23470E−03 | 5.32920E−04 | −1.35850E−04 |
| R4 | 3.94698E+00 | 2.77420E−02 | −1.17020E−03 | −8.15820E−04 | 6.36860E−04 | −2.00020E−04 |
| R5 | 2.47770E+01 | 1.37840E−02 | −5.79180E−03 | 7.95070E−04 | 2.22890E−04 | −1.43940E−04 |
| R6 | 3.20052E+00 | −9.38660E−03 | −9.72320E−04 | 4.27200E−04 | −1.15080E−04 | 1.55250E−05 |
| R7 | / | / | / | / | / | / |
| R8 | / | / | / | / | / | / |
| R9 | 6.56163E+00 | −1.37860E−03 | 4.25250E−05 | −8.08960E−05 | 1.89510E−05 | −3.55710E−06 |
| R10 | −4.85108E+01 | −4.43690E−02 | 1.09270E−02 | −2.16770E−03 | 3.17650E−04 | −3.32010E−05 |
| R11 | −9.17432E+00 | 7.06060E−03 | −1.02900E−02 | 3.87370E−03 | −1.06400E−03 | 2.05580E−04 |
| R12 | 1.65805E+00 | 4.37170E−03 | −6.02210E−03 | 1.36130E−03 | −1.97830E−04 | 1.86660E−05 |
| | Conic coefficient | Aspheric surface coefficients | | | | |
| | k | A14 | A16 | A18 | A20 | / |
| R1 | / | / | / | / | / | / |
| R2 | / | / | / | / | / | / |
| R3 | 2.50961E+03 | 1.99240E−05 | −1.55580E−06 | 4.68280E−08 | −3.40720E−11 | / |
| R4 | 3.94698E+00 | 3.44950E−05 | −3.02340E−06 | 1.00520E−07 | −4.90190E−10 | / |
| R5 | 2.47770E+01 | 3.43470E−05 | −4.19030E−06 | 2.57310E−07 | −6.37350E−09 | / |
| R6 | 3.20052E+00 | −1.07210E−06 | −3.26240E−09 | −1.22110E−09 | −3.54090E−10 | / |
| R7 | / | / | / | / | / | / |
| R8 | / | / | / | / | / | / |
| R9 | 6.56163E+00 | 3.24330E−07 | −1.47840E−08 | −2.14090E−11 | 3.40650E−12 | / |
| R10 | −4.85108E+01 | 2.28460E−06 | −9.19560E−08 | 1.61110E−09 | −9.08430E−14 | / |
| R11 | −9.17432E+00 | −2.68170E−05 | 2.23660E−06 | −1.06750E−07 | 2.20480E−09 | / |
| R12 | 1.65805E+00 | −1.08550E−06 | 3.52680E−08 | −4.07850E−10 | −1.49920E−11 | / |

Table 19 and Table 20 show design data of inflexion points and arrest points of each lens of the camera optical lens 50 in the fifth embodiment of the present disclosure.

TABLE 19

| | Number(s) of | Inflexion point | Inflexion point | Inflexion point |
|---|---|---|---|---|
| | inflexion points | position 1 | position 2 | position 3 |
| P1R1 | / | / | / | / |
| P1R2 | / | / | / | / |
| P2R1 | 2 | 0.255 | 2.285 | / |
| P2R2 | 1 | 0.755 | / | / |
| P3R1 | 3 | 0.605 | 1.025 | 1.985 |
| P3R2 | 1 | 2.035 | / | / |
| P4R1 | / | / | / | / |
| P4R2 | / | / | / | / |
| P5R1 | 1 | 1.925 | / | / |
| P5R2 | 1 | 0.365 | / | / |
| P6R1 | 2 | 1.095 | 3.015 | / |
| P6R2 | 1 | 1.395 | / | / |

TABLE 20

| | Number(s) of arrest | Arrest point position | Arrest point position |
|---|---|---|---|
| | points | 1 | 1 |
| P1R1 | / | / | / |
| P1R2 | / | | / |
| P2R1 | 2 | 0.425 | 2.585 |
| P2R2 | 1 | 1.355 | / |
| P3R1 | 1 | 2.305 | / |
| P3R2 | / | / | / |
| P4R1 | / | / | / |
| P4R2 | / | / | / |
| P5R1 | 1 | 2.565 | / |
| P5R2 | 1 | 0.635 | / |
| P6R1 | 1 | 2.005 | / |
| P6R2 | 1 | 2.435 | / |

In addition, in the following table 25, the values corresponding to the various parameters in the fifth embodiment and the parameters specified in the condition are listed.

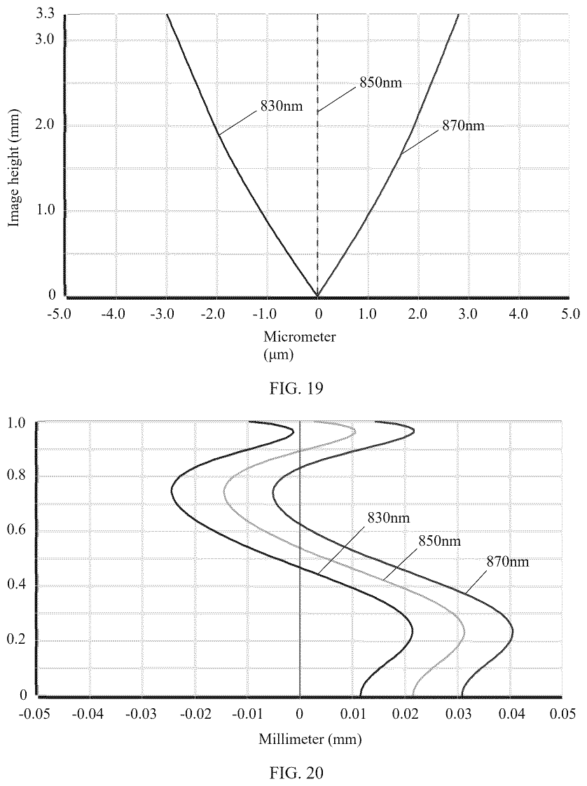

FIG. 18 shows a field curvature and a distortion after light with a wavelength of 850 nm passes through the camera optical lens 50 in the fifth embodiment. FIG. 19 shows a lateral color after light with wavelengths of 830 nm, 850 nm and 870 nm pass through the camera optical lens 50 in the fifth embodiment. FIG. 20 is a schematic diagram of a longitudinal aberration and a lateral color after light with wavelengths of 830 nm, 850 nm and 870 nm pass through the camera optical lens 50 in the fifth embodiment.

As shown in Table 25, the fifth embodiment satisfies the various conditions.

In this embodiment, an entrance pupil diameter (ENPD) of the camera optical lens 50 is 2.187 mm, an image height (IH) of 1.0H is 3.300 mm, and a field of view in a diagonal direction is 155.20°. Thus, the camera optical lens 50 meets the design requirement for large aperture, and miniaturization, the on-axis and off-axis aberrations are sufficiently corrected, thereby achieving excellent optical performance.

### COMPARATIVE EMBODIMENT

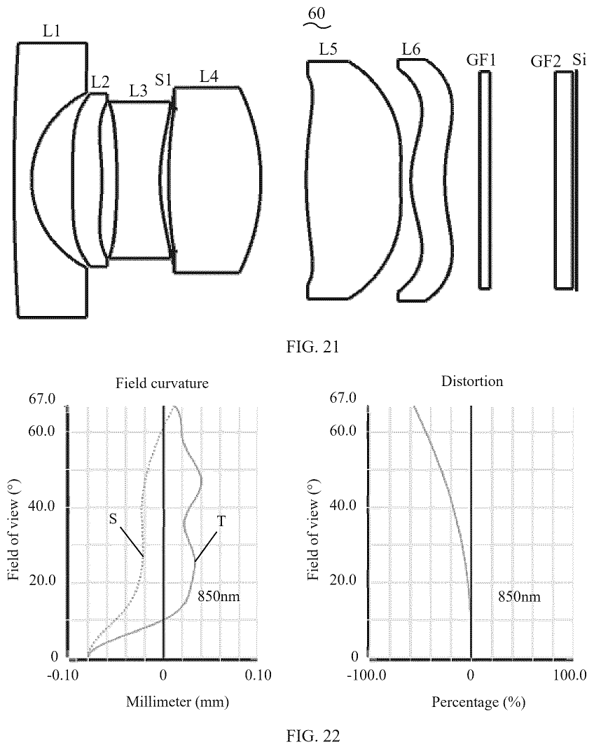

FIG. 21 is a schematic structural diagram of the camera optical lens 60 according to the comparative embodiment. The meanings of the symbols in the comparative embodiment are the same as the meanings of the symbols in the first embodiment. In the following, only differences are described.

Table 21 and Table 22 show design data of the camera optical lens 60 in the comparative embodiment of the present disclosure.

TABLE 21

| | R | d | | nd | | vd | |
|---|---|---|---|---|---|---|---|
| S1 | ∞ | d0= | −4.567 | | | | |
| R1 | 68.535 | d1= | 0.500 | nd1 | 1.6610 | vd1 | 20.53 |
| R2 | 2.949 | d2= | 1.189 | | | | |
| R3 | −103.242 | d3= | 0.840 | nd2 | 1.6393 | vd2 | 23.35 |
| R4 | −6.413 | d4= | 0.427 | | | | |
| R5 | −13.354 | d5= | 1.241 | nd3 | 1.5131 | vd3 | 56.22 |
| R6 | 5.415 | d6= | 0.250 | | | | |
| R7 | 14.763 | d7= | 2.656 | nd4 | 2.0007 | vd4 | 25.44 |
| R8 | −6.394 | d8= | 1.297 | | | | |
| R9 | 11.721 | d9= | 2.719 | nd5 | 1.5131 | vd5 | 56.22 |
| R10 | 16.046 | d10= | 0.294 | | | | |
| R11 | 2.925 | d11= | 0.978 | nd6 | 1.6393 | vd6 | 23.35 |
| R12 | 6.785 | d12= | 0.999 | | | | |
| R13 | ∞ | d13= | 0.300 | ndg1 | 1.5233 | vg1 | 54.52 |
| R14 | ∞ | d14= | 1.874 | | | | |
| R15 | ∞ | d15= | 0.500 | ndg2 | 1.5233 | vg2 | 54.52 |
| R16 | ∞ | d16= | 0.115 | | | | |

TABLE 22

| | Conic coefficient | Aspheric surface coefficients | | | | |
|---|---|---|---|---|---|---|
| | k | A4 | A6 | A8 | A10 | A12 |
| R1 | / | / | / | / | / | |
| R2 | / | / | / | / | / | / |
| R3 | 1.55047E+03 | 1.08850E−02 | 1.70150E−03 | −1.23540E−03 | 5.33960E−04 | −1.35550E−04 |
| R4 | 4.04171E+00 | 2.79300E−02 | −1.25690E−03 | −8.28860E−04 | 6.34870E−04 | −2.00580E−04 |
| R5 | 2.53038E+01 | 1.42390E−02 | −5.64660E−03 | 7.92760E−04 | 2.21070E−04 | −1.44870E−04 |
| R6 | 3.24051E+00 | −9.24150E−03 | −1.05060E−03 | 4.28480E−04 | −1.14290E−04 | 1.57080E−05 |
| R7 | / | / | / | / | / | / |
| R8 | / | / | / | / | / | / |
| R9 | 6.93611E+00 | −1.63650E−03 | 1.46460E−05 | −7.83760E−05 | 1.94570E−05 | −3.51100E−06 |
| R10 | −2.46794E+01 | −4.41220E−02 | 1.09420E−02 | −2.16620E−03 | 3.17750E−04 | −3.31930E−05 |
| R11 | −9.62981E+00 | 7.43760E−03 | −1.01980E−02 | 3.87920E−03 | −1.06450E−03 | 2.05460E−04 |
| R12 | 1.67481E+00 | 4.47090E−03 | −6.06030E−03 | 1.35920E−03 | −1.97840E−04 | 1.86680E−05 |
| | Conic coefficient | Aspheric surface coefficients | | | | |
| | k | A14 | A16 | A18 | A20 | / |
| R1 | / | / | / | / | / | / |
| R2 | / | / | / | / | / | / |
| R3 | 1.55047E+03 | 1.99580E−05 | −1.55360E−06 | 4.76520E−08 | 4.38170E−11 | / |
| R4 | 4.04171E+00 | 3.44290E−05 | −3.02670E−06 | 1.01050E−07 | 5.07750E−11 | / |
| R5 | 2.53038E+01 | 3.42160E−05 | −4.19350E−06 | 2.60470E−07 | −6.16530E−09 | / |
| R6 | 3.24051E+00 | −1.04510E−06 | 1.67700E−09 | 6.15610E−11 | −6.91470E−11 | / |
| R7 | / | / | / | / | / | / |
| R8 | / | / | / | / | / | / |
| R9 | 6.93611E+00 | 3.29030E−07 | −1.45670E−08 | −3.40410E−11 | 2.01640E−11 | / |
| R10 | −2.46794E+01 | 2.28530E−06 | −9.18920E−08 | 1.61690E−09 | 1.93690E−13 | / |
| R11 | −9.62981E+00 | −2.68300E−05 | 2.23640E−06 | −1.06660E−07 | 2.20070E−09 | / |
| R12 | 1.67481E+00 | −1.08670E−06 | 3.47100E−08 | −4.51110E−10 | −7.52790E−13 | / |

Table 23 and Table 24 show design data of inflexion points and arrest points of each lens of the camera optical lens 60 in the comparative embodiment.

TABLE 23

| | Number(s) of | Inflexion point | Inflexion point |
|---|---|---|---|
| | inflexion points | position 1 | position 2 |
| P1R1 | / | / | / |
| P1R2 | / | / | / |
| P2R1 | 2 | 0.275 | 2.515 |
| P2R2 | 1 | 0.755 | / |
| P3R1 | / | / | / |
| P3R2 | 1 | 1.715 | / |
| P4R1 | / | / | / |
| P4R2 | / | / | / |
| P5R1 | 1 | 1.765 | / |
| P5R2 | 1 | 0.355 | / |
| P6R1 | 2 | 1.105 | 3.265 |
| P6R2 | 1 | 1.295 | / |

TABLE 24

| | Number(s) of arrest points | Arrest point position 1 |
|---|---|---|
| P1R1 | / | / |
| P1R2 | / | / |
| P2R1 | 1 | 0.465 |
| P2R2 | 1 | 1.365 |
| P3R1 | / | / |
| P3R2 | / | / |
| P4R1 | / | / |
| P4R2 | / | / |
| P5R1 | 1 | 2.525 |
| P5R2 | 1 | 0.635 |
| P6R1 | 1 | 2.045 |
| P6R2 | 1 | 2.135 |

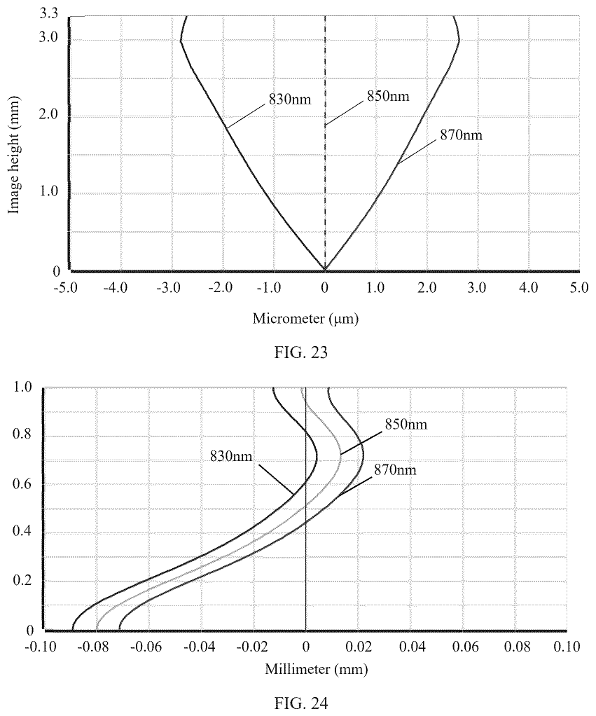

FIG. 22 shows a field curvature and a distortion after light with a wavelength of 850 nm passes through the camera optical lens 60 in the comparative embodiment. FIG. 23 shows a lateral color after light with wavelengths of 830 nm, 850 nm and 870 nm pass through the camera optical lens 60 in the comparative embodiment. FIG. 24 is a schematic diagram of a longitudinal aberration and a lateral color after light with wavelengths of 830 nm, 850 nm and 870 nm pass through the camera optical lens 60 in the comparative embodiment.

Table 25 lists the values of each of the conditions in the comparative embodiments according to the above conditions. Apparently, the camera optical lens 60 in the comparison embodiment does not satisfy the above condition: nd1≥1.70.

In the comparative embodiment, an entrance pupil diameter (ENPD) of the camera optical lens 60 is 2.463 mm, an image height (IH) of 1.0H is 3.300 mm, and a field of view (FOV) in a diagonal direction is 133.90°. Thus, the camera optical lens 60 does not have excellent optical, and the on-axis and off-axis aberrations are not sufficiently corrected.

TABLE 25

| Parameters and | | | | | | |
|---|---|---|---|---|---|---|
| conditional | First | Second | Third | Fourth | Fifth | Comparative |
| equations | embodiment | embodiment | embodiment | embodiment | embodiment | embodiment |
| nd1 | 2.001 | 2.001 | 2.104 | 1.713 | 2.001 | 1.661 |
| (FOV*f)/IH | 130.455 | 130.106 | 125.472 | 121.629 | 134.078 | 130 |
| R5/R6 | −2.519 | −1.206 | −3.167 | −2.589 | −4.993 | −2.466 |
| R7/R8 | −2.078 | −1.008 | −1.905 | −2.311 | −3.982 | −2.309 |
| d9/d11 | 2.749 | 1.400 | 4.081 | 4.986 | 2.262 | 2.779 |
| f12/f | −2.717 | −2.601 | −1.208 | −5.967 | −2.663 | −3.753 |
| f | 2.908 | 2.745 | 3.575 | 2.804 | 2.844 | 3.202 |
| f1 | −3.757 | −3.489 | −2.904 | −4.966 | −3.735 | −4.841 |
| f2 | 10.491 | 10.747 | 11.859 | 10.183 | 10.786 | 10.996 |
| f3 | −7.523 | −10.013 | −8.36 | −7.179 | −8.458 | −7.448 |
| f4 | 4.778 | 4.928 | 4.384 | 5.004 | 4.941 | 4.896 |
| f5 | 66.159 | 44.273 | 31.344 | 85.238 | 49.623 | 70.948 |
| f6 | 7.754 | 7.981 | 6.605 | 7.614 | 7.969 | 7.562 |
| f12 | −7.900 | −7.139 | −4.317 | −16.731 | −7.573 | −12.017 |
| FNO | 1.30 | 1.30 | 1.30 | 1.30 | 1.30 | 1.30 |

It will be understood by those skilled in the art that the embodiments described above are specific embodiments realizing the present disclosure. In practice, various changes may be made to these embodiments in form and in detail without departing from the spirit and scope of the disclosure.

What is claimed is:

1. A camera optical lens, comprising in sequence from an object side to an image side: a first lens, a second lens, a third lens, a fourth lens, a fifth lens, and a sixth lens;
wherein the camera optical lens satisfies the following conditions:
$$nd 1 \geq 1.7 ; and$$
$$( FOV * f ) / IH \geq 12 \; 0 \text{.00} ;$$
wherein nd1 represents a refractive index of the first lens;
FOV represents a field of view of the camera optical lens;
f represents a focal length of the camera optical lens; and
IH represents an image height of the camera optical lens.

2. The camera optical lens of claim 1, wherein the camera optical lens further satisfies the following condition:
$$- 5. \leq R 5 / R 6 \leq - 1 \text{.20} ;$$
wherein R5 represents a curvature radius of an object-side surface of the third lens; and
R6 represents a curvature radius of an image-side surface of the third lens.

3. The camera optical lens of claim 1, wherein the camera optical lens further satisfies the following condition:
$$- 4.00 \leq R 7 / R 8 \leq - 1.00 ;$$
wherein R7 represents a curvature radius of an object-side surface of the fourth lens; and
R8 represents a curvature radius of an image-side surface of the fourth lens.

4. The camera optical lens of claim 1, wherein the camera optical lens further satisfies the following condition:
$$1. 40 \leq d 9 / d 11 \leq 5. ;$$
wherein d9 represents an on-axis thickness of the fifth lens, and
d11 represents an on-axis thickness of the sixth lens.

5. The camera optical lens of claim 1, wherein the camera optical lens further satisfies the following condition:
$$- 6.00 \leq f 12 / f \leq - 1 \text{.20} ;$$
wherein f12 represents a combined focal length of the first lens and the second lens.

6. The camera optical lens of claim 1, wherein the field of view FOV and the focal length f further satisfy the following condition:
$$( FOV * f ) / IH \leq 150.00 .$$

7. The camera optical lens of claim 1, wherein the first lens has a negative refractive power, and an image-side surface of the first lens is concave in a paraxial region,
wherein the camera optical lens further satisfies the following conditions:
$$0.33 \leq ( R 1 + R 2 ) / ( R 1 - R 2 ) \leq 1.97 ;$$
$$- 3.54 \leq f 1 / f \leq - 0 \text{.54} ; and$$
$$0.02 \leq d 1 / TTL \leq 0.22 ;$$
wherein R1 represents a curvature radius of an object-side surface of the first lens;
R2 represents a curvature radius of the image-side surface of the first lens;
f1 represents a focal length of the first lens;
d1 represents an on-axis thickness of the first lens; and
TTL represents a total track length of the camera optical lens.

8. The camera optical lens of claim 1, wherein the second lens has a positive refractive power, an object-side surface of the second lens is concave in a paraxial region, and an image-side surface of the second lens is convex in the paraxial region;
wherein the camera optical lens further satisfies the following conditions:
$$0.54 \leq ( R 3 + R 4 ) / ( R 3 - R 4 ) \leq 1.71 ;$$
$$1.66 \leq f 2 / f \leq 5.87 ; and$$
$$0.02 \leq d 3 / TTL \leq 0 \text{.09} ;$$
wherein R3 represents a curvature radius of the object-side surface of the second lens;
R4 represents a curvature radius of the image-side surface of the second lens;
f2 represents a focal length of the second lens;
d3 represents an on-axis thickness of the second lens; and
TTL represents a total track length of the camera optical lens.

9. The camera optical lens of claim 1, wherein the third lens has a negative refractive power, an object-side surface of the third lens is concave in a paraxial region, and an image-side surface of the third lens is concave in the paraxial region;
wherein the camera optical lens further satisfies the following conditions:
$$0.05 \leq ( R 5 + R 6 ) / ( R 5 - R 6 ) \leq 1. ;$$
$$- 7.3 \; 0 \leq f 3 / f \leq - 1 \text{.56} ; AND$$
$$0.02 \leq d 5 / TTL \leq 0 \text{.12} ;$$
wherein R5 represents a curvature radius of the object-side surface of the third lens;
R6 represents a curvature radius of the image-side surface of the third lens;
f3 represents a focal length of the third lens;
d5 represents an on-axis thickness of the third lens; and
TTL represents a total track length of the camera optical lens.

10. The camera optical lens of claim 1, wherein the fourth lens has a positive refractive power, an object-side surface of the fourth lens is convex in a paraxial region, and an image-side surface of the fourth lens is convex in the paraxial region;
wherein the camera optical lens further satisfies the following conditions:
$$0. \leq ( R 7 + R 8 ) / ( R 7 - R 8 ) \leq 0.9 ;$$
$$0.61 \leq f 4 / f \leq 2.69 ; and$$
$$0.03 \leq d 7 / TTL \leq 0.27 ;$$
wherein R7 represents a curvature radius of the object-side surface of the fourth lens;
R8 represents a curvature radius of the image-side surface of the fourth lens;
f4 represents a focal length of the fourth lens;
d7 represents an on-axis thickness of the fourth lens; and
TTL represents a total track length of the camera optical lens.

11. The camera optical lens of claim 1, wherein the fifth lens has a positive refractive power, an object-side surface of the fifth lens is convex in a paraxial region, and an image-side surface of the fifth lens is concave in the paraxial region;
wherein the camera optical lens further satisfies the following conditions:
$$- 17.54 \leq ( R 9 + R 10 ) / ( R 9 - R 10 ) \leq - 1.95 ;$$
$$4.38 \leq f 5 / f \leq 45.6 ; and$$
$$0.06 \leq d 9 / TTL \leq 0 \text{.36} ;$$
wherein R9 represents a curvature radius of the object-side surface of the fifth lens;
R10 represents a curvature radius of the image-side surface of the fifth lens;
f5 represents a focal length of the fifth lens;
d9 represents an on-axis thickness of the fifth lens; and
TTL represents a total track length of the camera optical lens.

12. The camera optical lens of claim 1, wherein the sixth lens has a positive refractive power, an object-side surface of the sixth lens is convex in a paraxial region, and an image-side surface of the sixth lens is concave in the paraxial region;
wherein the camera optical lens further satisfies the following conditions:
$$- 5.98 \leq ( R 11 + R 12 ) / ( R 11 - R 12 ) \leq - 1.5 ;$$
$$0.92 \leq f 6 / f \leq 4.36 ; and$$
$$0.02 \leq d 11 / TTL \leq 0 \text{.14} ;$$
wherein R11 represents a curvature radius of the object-side surface of the sixth lens;
R12 represents a curvature radius of the image-side surface of the sixth lens;
f6 represents a focal length of the sixth lens;
d11 represents an on-axis thickness of the fifth lens; and
TTL represents a total track length of the camera optical lens.

13. The camera optical lens of claim 1, wherein the fourth lens is made of glass.
